(19) United States
(12) Patent Application Publication
(10) Pub. No.: US 2025/0358835 A1
(43) Pub. Date: Nov. 20, 2025

(54) DEVICE AND METHOD FOR SIDELINK TRANSMISSION/RECEPTION IN WIRELESS COMMUNICATION SYSTEM

(71) Applicant: Samsung Electronics Co., Ltd., Suwon-si (KR)

(72) Inventors: Gwanmo KU, Suwon-si (KR); Jaehong KWON, Suwon-si (KR); Changyeon KIM, Suwon-si (KR); Jaeyoung PARK, Suwon-si (KR); Heon SHIN, Suwon-si (KR)

(21) Appl. No.: 19/285,586

(22) Filed: Jul. 30, 2025

Related U.S. Application Data
(63) Continuation of application No. PCT/KR2024/095041, filed on Jan. 22, 2024.

(30) Foreign Application Priority Data
Feb. 3, 2023 (KR) 10-2023-0014645
Feb. 7, 2023 (KR) 10-2023-0016433

(51) Int. Cl. H04W 72/40; H04L 5/00; H04W 72/25

(52) U.S. Cl. CPC H04W 72/40; H04L 5/0005; H04W 72/25

(57) ABSTRACT

A first terminal of a wireless communication system is provided. The first terminal includes a transceiver, memory, comprising one or more storage media, storing instructions, and one or more processors communicatively coupled to the transceiver and the memory, wherein the instructions, when executed by the one or more processors individually or collectively, cause the first terminal to receive at least one of a first signal broadcasted from a second terminal or a second signal broadcasted from a third terminal, determine whether retransmission is needed or whether a collision occurs, based on at least one of the first signal or the second signal, and broadcast a third signal comprising frequency resource information, time resource information, and status information determined based on whether the retransmission is needed or whether the collision occurs.

### CROSS-REFERENCE TO RELATED APPLICATION(S)

This application is a continuation application, claiming priority under 35 U.S.C. § 365 (c), of an International application No. PCT/KR2024/095041, filed on Jan. 22, 2024, which is based on and claims the benefit of a Korean patent application number 10-2023-0014645, filed on Feb. 3, 2023, in the Korean Intellectual Property Office, and of a Korean patent application number 10-2023-0016433, filed on Feb. 7, 2023, in the Korean Intellectual Property Office, the disclosure of each of which is incorporated by reference herein in its entirety.

### BACKGROUND

### 1. Field

The disclosure relates to a wireless communication system (or mobile communication system). More particularly, the disclosure relates to a device and a method for performing sidelink transmission/reception.

### 2. Description of Related Art

5^{th} generation (5G) mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as millimeter wave (mmWave) such as 28 GHz and 39 GHz. In addition, it has been considered to implement 6^{th} generation 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive multi-input multi-output (MIMO) for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large-capacity data transmission and a polar code for highly reliable transmission of control information, layer 2 (L2) pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the development of a wireless communication system, various technologies, such as sidelink-based communication (e.g., vehicle-to-everything (V2X)), may be supported, and a method for smoothly providing side communication is increasingly needed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method for performing sidelink transmission/reception.

Additional aspects will be set forth in part in the description which follows and, in part, will be apparent from the description, or may be learned by practice of the presented embodiments.

In accordance with an aspect of the disclosure, a first terminal in a wireless communication system is provided. The first terminal includes a transceiver, memory, comprising one or more storage media, storing instructions, and one or more processors communicatively coupled to the transceiver and the memory, wherein the instructions, when executed by the one or more processors individually or collectively, cause the first terminal to receive at least one of a first signal broadcast from a second terminal or a second signal broadcast from a third terminal, determine whether retransmission is needed or whether a collision occurs, based on at least one of the first signal or the second signal, and broadcast a third signal comprising frequency resource information, time resource information, and status information determined based on whether the retransmission is needed or whether the collision occurs.

In accordance with another aspect of the disclosure, a second terminal in a wireless communication system is provided. The second terminal includes a transceiver, memory, comprising one or more storage media, storing instructions, and one or more processors communicatively coupled to the transceiver and the memory, wherein the instructions, when executed by the one or more processors individually or collectively, cause the second terminal to broadcast a first signal, receive a third signal broadcast from a first terminal receiving at least one of the first signal or a second signal broadcast from a third terminal, obtain frequency resource information, time resource information, and status information from the third signal, and perform communication with the first terminal, based on at least one of the frequency resource information, the time resource information, or the status information.

In accordance with another aspect of the disclosure, a method performed by a first terminal is provided. The method includes receiving, by the first terminal, at least one of a first signal broadcast from a second terminal or a second signal broadcast from a third terminal, determining, by the first terminal, whether retransmission is needed or whether a collision occurs, based on at least one of the first signal or the second signal, and broadcasting, by the first terminal, a third signal including frequency resource information, time resource information, and status information determined based on whether the retransmission is needed or whether the collision occurs.

In accordance with another aspect of the disclosure, A method performed by a second terminal is provided. The method includes broadcasting, by the second terminal, a first signal, receiving, by the second terminal, a third signal broadcast from a first terminal receiving at least one of the first signal or a second signal broadcast from a third terminal, obtaining, by the second terminal, frequency resource information, time resource information, and status information from the third signal, and performing, by the second terminal, communication with the first terminal, based on at least one of the frequency resource information, the time resource information, or the status information.

In accordance with another aspect of the disclosure, one or more non-transitory computer-readable storage media storing one or more computer programs including computer-executable instructions that, when executed by one or more processors of a first terminal individually or collectively, cause the first terminal to perform operations are provided. The operations include receiving, by the first terminal, at least one of a first signal broadcast from a second terminal or a second signal broadcast from a third terminal, determining, by the first terminal, whether retransmission is needed or whether a collision occurs, based on at least one of the first signal or the second signal, and broadcasting, by the first terminal, a third signal including frequency resource information, time resource information, and status information determined based on whether the retransmission is needed or whether the collision occurs.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates examples of scenarios of sidelink communication in a wireless communication system according to an embodiment of the disclosure;

FIG. 2 illustrates examples of scenarios of sidelink communication in a wireless communication system according to an embodiment of the disclosure;

FIG. 3 illustrates examples of scenarios of sidelink communication in a wireless communication system according to an embodiment of the disclosure;

FIG. 4 illustrates examples of scenarios of sidelink communication in a wireless communication system according to an embodiment of the disclosure;

FIG. 5 illustrates examples of transmission modes of sidelink communication in a wireless communication system according to an embodiment of the disclosure;

FIG. 6 illustrates examples of transmission modes of sidelink communication in a wireless communication system according to an embodiment of the disclosure;

FIG. 7 illustrates an example of a resource pool of a sidelink in a wireless communication system according to an embodiment of the disclosure;

FIG. 8 illustrates an example of signal flow for allocating a transmission resource of a sidelink in a wireless communication system according to an embodiment of the disclosure;

FIG. 9 illustrates another example of signal flow for allocating a transmission resource of a sidelink in a wireless communication system according to an embodiment of the disclosure;

FIG. 10 illustrates an example illustrating a scenario in which a signal is normally received or power ramping is required in a wireless communication system according to an embodiment of the disclosure;

FIG. 11 illustrates an example of a scenario in which a collision may occur in a wireless communication system according to an embodiment of the disclosure;

FIG. 12 is a flowchart illustrating a process in which a first UE operates in a wireless communication system according to an embodiment of the disclosure;

FIG. 13 is a flowchart illustrating a process in which a second UE operates in a wireless communication system according to an embodiment of the disclosure;

FIG. 14 is a diagram schematically illustrating data included in a signal broadcasted in a wireless communication system according to an embodiment of the disclosure;

FIG. 15 illustrates an example of a frequency resource set and a time resource set of a sidelink in a wireless communication system according to an embodiment of the disclosure;

FIG. 16 illustrates an example in which no collision occurs in a sidelink of a wireless communication system according to an embodiment of the disclosure;

FIG. 17 illustrates an example in which a collision occurs in a sidelink of a wireless communication system according to an embodiment of the disclosure;

FIG. 18 illustrates another example in which a collision occurs in a sidelink of a wireless communication system according to an embodiment of the disclosure; and

FIG. 19 illustrates a structure of a UE according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Hereinafter, various embodiments of the disclosure will be described based on an approach of hardware. However, various embodiments of the disclosure include a technology that uses both hardware and software, and thus the various embodiments of the disclosure may not exclude the perspective of software.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) or new radio (NR) standards are used for the sake of descriptive convenience. However, the disclosure is not limited by these terms and names, and may be applied in the same way to systems that conform other standards.

In the following description, a base station (BS) is an entity that allocates resources to terminals, and may be at least one of a radio access network (RAN) node, a next generation node B (gNode B, gNB), an evolved node B (eNode B, eNB), a Node B, a wireless access unit, a base station controller, and a node on a network. In the disclosure, the term “eNB” may be interchangeably used with the term “gNB” for the sake of descriptive convenience. That is, a base station described as “eNB” may refer to “gNB”.

A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5^{th} generation mobile communication standard). The disclosure may be applied to intelligent services (e.g., smart homes, smart buildings, smart cities, smart cars or connected cars, healthcare, digital education, retail business, security and safety-related services, etc.) on the basis of 5G communication technology and Internet of things (IoT)-related technology. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a terminal (or UE) transmits data or control signals to a base station (or eNB or gNB), and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHZ or more, instead of transmitting signals using a transmission bandwidth up to 20 MHZ in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 105 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely examples of different types of services, and service types to which the disclosure is applied are not limited to the above examples.

Furthermore, in the following description, LTE, LTE-A, LTE Pro, 5G (or NR), or 6G systems will be described by way of example, but the embodiments of the disclosure may also be applied to other communication systems having similar technical backgrounds or channel types. Moreover, based on determinations by those skilled in the art, the embodiments of the disclosure may also be applied to other communication systems through some modifications without significantly departing from the scope of the disclosure.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as described below, and other terms referring to subjects having equivalent technical meanings may be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

As used in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications.

As used herein, a “transmitting UE” may refer to a UE which transmits sidelink data or control information or a UE which receives sidelink feedback information. In addition, as used herein, a “receiving UE” may refer to a UE which receives sidelink data or control information or a UE which transmits sidelink feedback information.

Various attempts have been made to apply the 5G communication system to IoT networks. For example, technologies such as a sensor network, machine-to-machine (M2M) communication, machine type communication (MTC) may be implemented by beamforming, MIMO, and array antenna techniques that are 5G communication technologies. Application of a cloud radio access network (cloud RAN) as the big data processing technology may also be considered an example of convergence of the 5G technology with the IoT technology. As such, a plurality of services may be provided to a user in a communication system, and in order to provide such a plurality of services to a user, a method for providing each service within the same time period according to the characteristics and an apparatus using the same are required. Various services to be provided in the 5G communication system are being studied, and one of them is a service that satisfies the requirements for low latency and high reliability.

In the case of vehicle communication, the standardization of LTE-based vehicle to everything (V2X) systems has been completed based on device-to-device (D2D) communication structures in the 3GPP Rel 14 and Rel-15, and efforts are currently made to develop V2X systems based on 5G new radio (NR). In NR V2X systems, UE-to-UE unicast communication, groupcast (or multicast) communication, and broadcast communication will be supported. In addition, unlike LTE V2X aiming to transmit and receive basic safety information required for road driving of vehicles, NR V2X aims to provide further-evolved services such as platooning, advanced driving, extended sensors, and remote driving.

Based on the foregoing discussion, the disclosure proposes a method for enabling scheduling in providing sidelink communication or vehicle-to-everything (V2X) communication in a wireless communication system (or mobile communication system).

In sidelink communication or V2X communication considered in a wireless communication system (or mobile communication system), broadcast-based communication may be performed between out-of-coverage UEs considering control signaling overhead. UEs unable to communicate directly or indirectly with a base station (BS) may perform short-range communication between the UEs by using a broadcasting technique to transmit information in one direction. Content of broadcasted data may include, for example, a warning message. Alternatively, for example, a platooning service provided to perform autonomous driving requires a reliable communication technique to control a vehicle through one-way communication. Since communication using feedback is required in order to secure high reliability, a device and method for providing reliable communication in broadcast communication that transmits a signal in one direction are provided.

Technical aspects to be achieved in the disclosure are not limited to the technical aspects mentioned above, and other technical aspects not mentioned will be clearly understood by those skilled in the art from the description of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

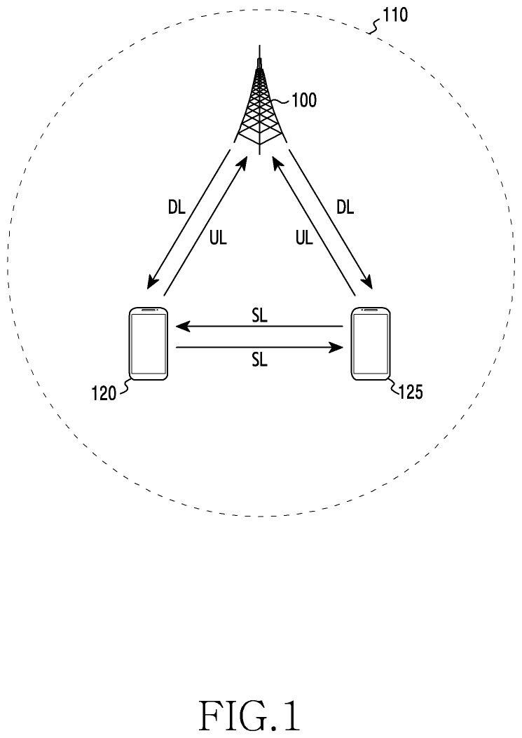

FIGS. 1 to 4 illustrate examples of scenarios of sidelink communication in a wireless communication system according to various embodiments of the disclosure.

Referring to FIG. 1, FIG. 1 illustrates an in-coverage (IC) scenario in which sidelink UEs 120 and 125 are located within coverage 110 of a base station 100 according to an embodiment of the disclosure. The sidelink UEs 120 and 125 may receive data and control information from the base station through a downlink (DL), or may transmit data and control information to the base station through an uplink (UL). The data and control information may be data and control information for sidelink communication or data and control information for general cellular communication other than sidelink communication. In addition, the sidelink UEs 120 and 125 in FIG. 1 may transmit and receive data and control information for sidelink communication through a sidelink.

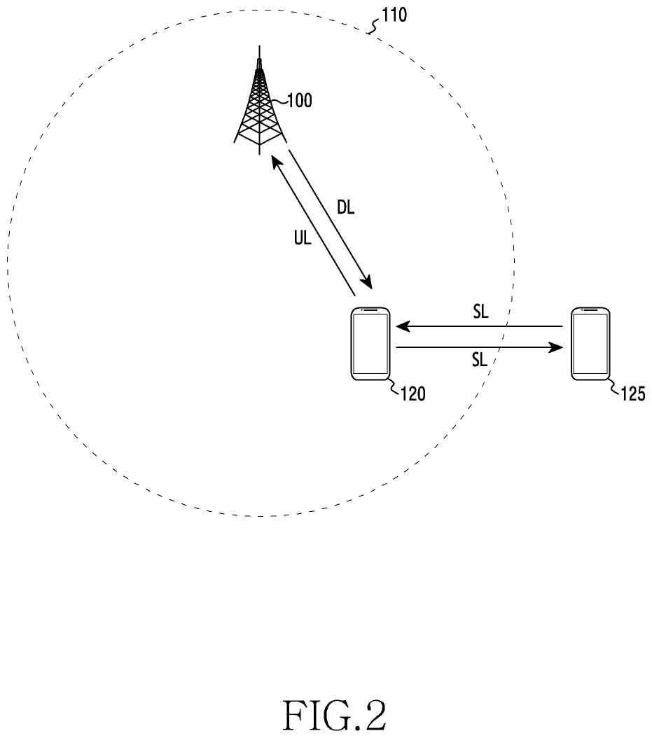

Referring to FIG. 2, FIG. 2 illustrates a partial-coverage (PC) scenario in which a first UE 120 among sidelink UEs is located within the coverage 110 of a base station 100 and a second UE 125 is located outside the coverage 110 of the base station 100 according to an embodiment of the disclosure. The first UE 120 located within the coverage 110 of the base station 100 may receive data and control information from the base station through a downlink, or may transmit data and control information to the base station through an uplink. The second UE 125 located outside the coverage of the base station 100 is unable to receive data and control information from the base station through the downlink, and is unable to transmit data and control information to the base station through the uplink. The second UE 125 may transmit and receive data and control information for sidelink communication to and from the first UE 120 through a sidelink.

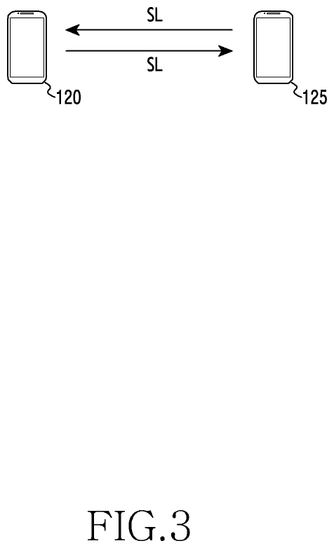

Referring to FIG. 3, FIG. 3 illustrates an out-of-coverage (OOC) scenario in which sidelink UEs (e.g., a first UE 120 and a second UE 125) are located outside coverage 110 of a base station 100 according to an embodiment of the disclosure. Therefore, the first UE 120 and the second UE 125 are unable to receive data and control information from the base station through a downlink, and are unable to transmit data and control information to the base station through an uplink. The first UE 120 and the second UE 125 may transmit and receive data and control information for sidelink communication through a sidelink.

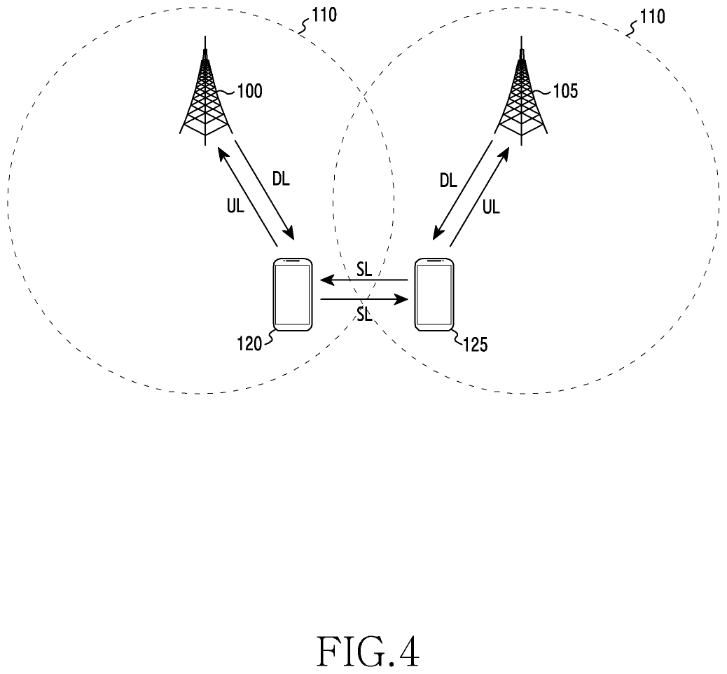

Referring to FIG. 4, FIG. 4 illustrates a case in which a first UE 120 and a second UE 125 performing sidelink communication performs inter-cell sidelink communication when connected to different base stations (e.g., a first base station 100 and a second base station 105) (e.g., a radio resource control (RRC)-connected state) or camping on the different base stations (e.g., an RRC-disconnected state, i.e., an RRC idle state) according to an embodiment of the disclosure. The first UE 120 may be a sidelink transmitting UE, and the second UE 125 may be a sidelink receiving UE. Alternatively, the first UE 120 may be a sidelink receiving UE, and the second UE 125 may be a sidelink transmitting UE. The first UE 120 may receive a sidelink-exclusive system information block (SIB) from the base station 100 to which the first UE 120 is connected (or on which the first UE 120 is camping), and the second UE 125 may receive a sidelink-exclusive SIB from the different base station (e.g., second base station 105) to which the second UE 125 is connected (or on which the second UE 125 is camping). Here, information of the sidelink-exclusive SIB received by the first UE 120 and information of the sidelink-exclusive SIB received by the second UE 125 may be different from each other. Therefore, to perform sidelink communication between UEs located in different cells, pieces of information need to be unified, or an additional method for assuming and interpreting the pieces of information may be required.

Although the examples of FIGS. 1 to 4 show a sidelink system including two UEs (e.g., the first UE 120 and the second UE 125) for convenience of explanation, the disclosure is not limited thereto and may be applied to a sidelink system in which three or more UEs participate. Further, an uplink and a downlink between the base station 100 and sidelink UEs may be referred to as a Uu interface, and a sidelink between sidelink UEs may be referred to as a PC5 interface. In the following description, an uplink or a downlink and a Uu interface may be used interchangeably, and a sidelink and PC5 may be used interchangeably.

In the disclosure, a UE may refer to a vehicle supporting vehicle-to-vehicle (V2V) communication, a vehicle or a handset (e.g., smartphone) of a pedestrian supporting vehicle-to-pedestrian (V2P) communication, a vehicle supporting vehicle-to-network (V2N) communication, or a vehicle supporting vehicle-to-infrastructure (V2I) communication. Further, in the disclosure, a UE may refer to a roadside unit (RSU) including a UE function, an RSU including a base station function, or an RSU including part of a base station function and part of a UE function.

In the disclosure, a base station may be a base station supporting both V2X communication and general cellular communication, or a base station supporting only V2X communication. Here, the base station may refer to a 5G base station (gNB), a 4^{th} generation (4G) base station (eNB), or an RSU. In the disclosure, a base station may be referred to as an RSU.

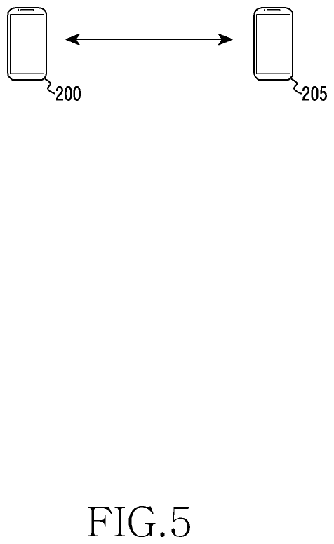

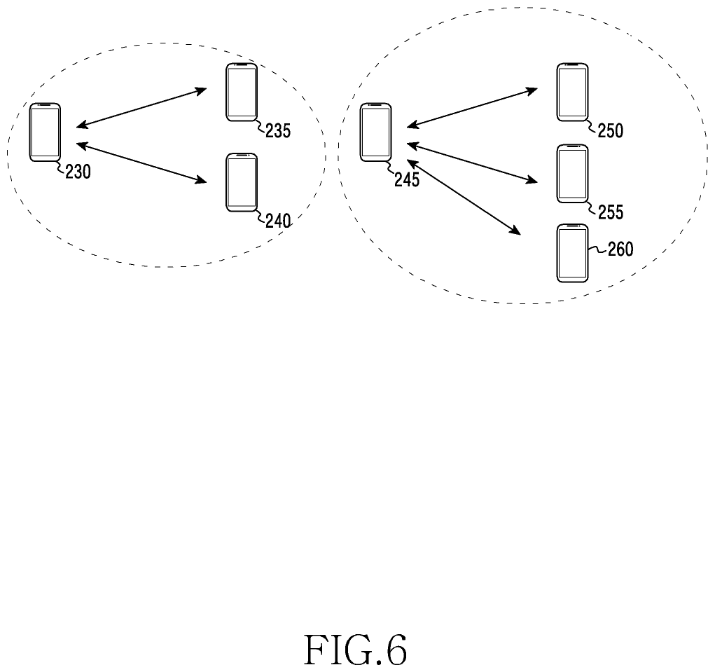

FIGS. 5 and 6 illustrate examples of transmission modes of sidelink communication in a wireless communication system according to various embodiments of the disclosure. FIG. 5 illustrates an example of a unicast mode according to an embodiment of the disclosure. FIG. 6 illustrates an example of a groupcast mode according to an embodiment of the disclosure.

Referring to FIG. 5, a transmitting UE 200 and a receiving UE 205 may perform one-to-one communication. A transmission mode illustrated in FIG. 5 may be referred to as unicast communication. Referring to FIG. 6, a transmitting UE 230 or 245 and receiving UEs 235, 240, 250, 255, and 260 may perform one-to-many communication. A transmission mode illustrated in FIG. 6 may be referred to as groupcast or multicast.

Referring to FIG. 6, a first UE 230, a second UE 235, and a third UE 240 may form one group and perform groupcast communication, and a fourth UE 245, a fifth UE 250, a sixth UE 255, and a seventh UE 260 may form another group and perform groupcast communication. UEs perform groupcast communication within a group to which the UEs belong, and may also perform unicast, groupcast, or broadcast communication with at least one other UE belonging to a different group. Although FIG. 6 illustrates two groups, the disclosure is not limited thereto, and a greater number of groups may be formed.

Although not shown separately, sidelink UEs may perform broadcast communication. Broadcast communication may refer to a mode in which all sidelink UEs receive data and control information transmitted by a sidelink transmitting UE through a sidelink. For example, in FIG. 6, when the first UE 230 is a transmitting UE, the remaining UEs 235, 240, 245, 250, 255, and 260 may receive data and control information transmitted by the first UE 230.

The foregoing sidelink unicast communication, groupcast communication, and broadcast communication may be supported in an in-coverage scenario, a partial-coverage scenario, or an out-of-coverage scenario.

In an NR sidelink, unlike an LTE sidelink, supporting a transmission form in which a vehicular UE transmits data only to one specific UE through unicast and a transmission form in which a vehicular UE transmits data to a plurality of specific UEs through groupcast may be considered. For example, when considering a service scenario such as platooning, which is a technology of connecting two or more vehicles via one network and driving the vehicles in a group, unicast and groupcast technologies may be usefully used. Specifically, unicast communication may be used for a leader UE of a group connected through platooning to control one specific UE, and groupcast communication may be used to simultaneously control the group including a plurality of specific UEs.

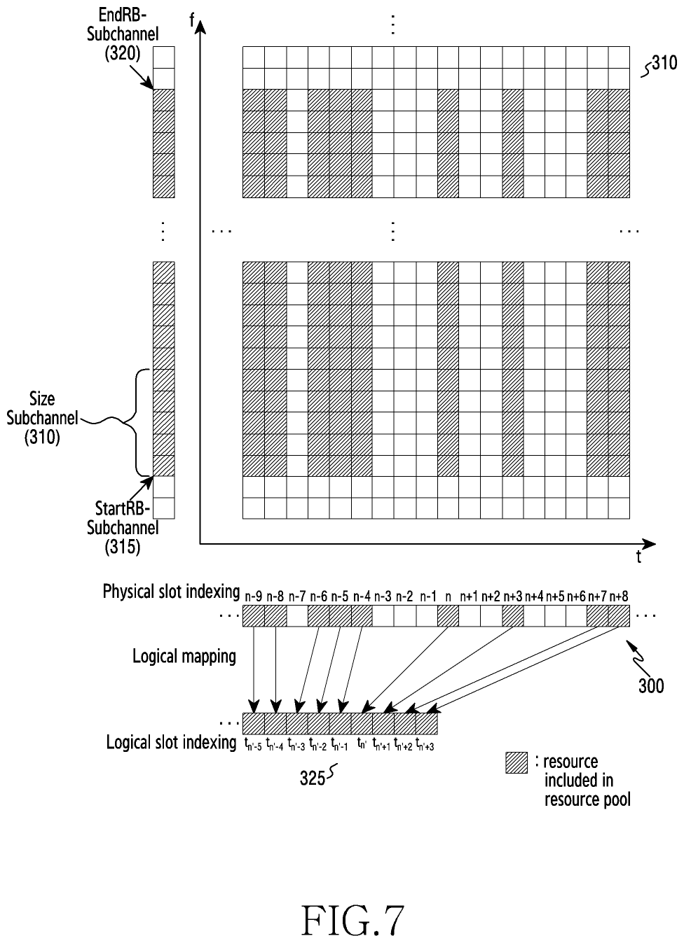

FIG. 7 illustrates an example of a resource pool of a sidelink in a wireless communication system according to an embodiment of the disclosure. The resource pool may be defined as a set of resources in time and frequency domains used for sidelink transmission and reception.

In the resource pool, a resource granularity on a time axis may be one or more orthogonal frequency division multiplexing (OFDM) symbols. A resource granularity on a frequency axis may be one or more physical resource blocks (PRBs).

When a resource pool is allocated in the time domain and the frequency domain, an area including resources marked with slashes indicates an area configured as a resource pool in time and frequency. Although the disclosure illustrates a case in which the resource pool is allocated non-consecutively in time, the disclosure is not limited thereto and may also be applied to a case in which the resource pool is allocated consecutively in time. Further, although the disclosure illustrates a case in which the resource pool is allocated consecutively in frequency, the disclosure is not limited thereto and may also be applied to a case in which the resource pool is allocated non-consecutively in frequency.

Referring to FIG. 7, a time area 300 of the configured resource pool shows a case in which resources are allocated non-consecutively in the time domain. In the time area 300 of the resource pool, a resource granularity on the time axis may be a slot. Specifically, one slot including fourteen OFDM symbols may be a basic resource granularity on the time axis. Referring to the time area 300 of the configured resource pool, shaded slots represent slots allocated to the resource pool in time, and the slots allocated to the resource pool in time may be indicated using system information. For example, the slots allocated to the resource pool in time may be indicated using resource pool configuration information in time within a SIB. Specifically, at least one slot configured as the resource pool in time may be indicated through a bitmap. Referring to FIG. 7, physical slots of the time area 300 belonging to a non-consecutive resource pool on the time axis may be mapped to logical channel slots 325. Generally, a set of slots belonging to a resource pool for a physical sidelink shared channel (PSSCH) may be expressed as (t₀, t₁, . . . , tᵢ, . . . , t_{Tmax}).

Referring to FIG. 7, the start position of a subchannel on the frequency axis in the resource pool may be indicated by start RB-Subchannel 315. When resource allocation on the frequency axis is performed in a unit of a subchannel 310, resource pool configuration on the frequency axis may be performed through configuration information about an RB index (start-Subchannel) 315 at which the subchannel starts, information (sizeSubchannel) of subchannel 310 indicating the number of RBs included in the subchannel, and the total number of subchannels (numSubchannel). In addition, subchannels allocated to the resource pool on the frequency axis may be indicated using the system information through configuration information about an RB index (EndRB-Subchannel) 320 at which the subchannel ends. For example, at least one of startRB-Subchannel, sizeSubchannel, EndRB-SubChannel, and numSubchannel may be indicated as frequency resource pool configuration information in the SIB. When a subchannel for a physical sidelink feedback channel (PSFCH) is defined independently from a PSSCH, subchannel configuration information about each of the PSFCH and the PSSCH may be indicated to UE.

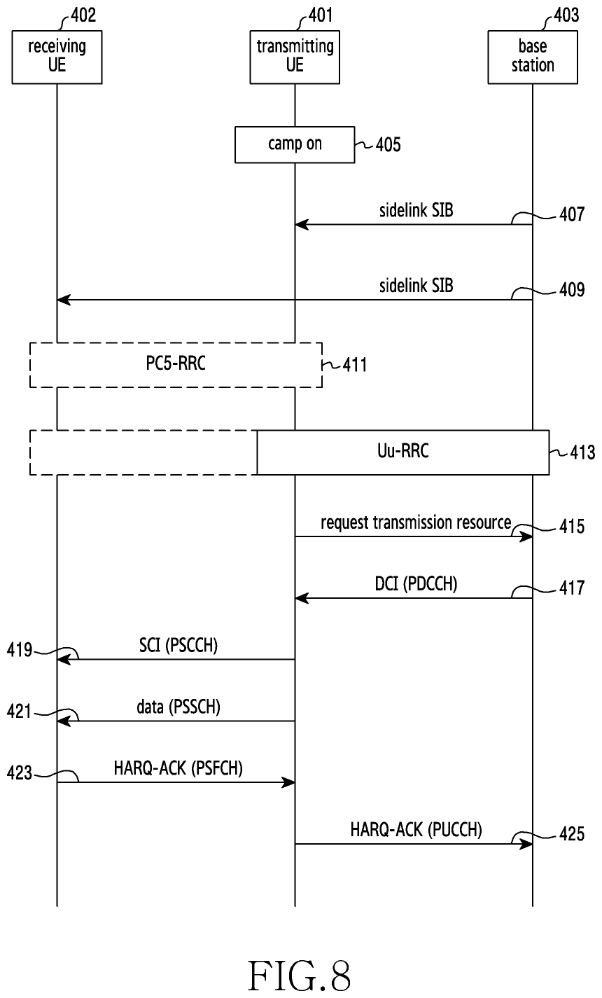

FIG. 8 illustrates an example of signal flow for allocating a transmission resource of a sidelink in a wireless communication system according to an embodiment of the disclosure. FIG. 8 illustrates a signal exchange between a transmitting UE 401, a receiving UE 402, and a base station 403.

As described below, a mode in which the base station allocates a transmission resource for sidelink communication may be referred to as mode 1. Mode 1 is a method based on scheduled resource allocation by the base station. More specifically, in mode-1 resource allocation, the base station may allocate a resource used for sidelink transmission to RRC-connected UEs according to a dedicated scheduling method. Since the base station is able to manage a sidelink resource, scheduled resource allocation is favorable for interference management and resource pool management (e.g., dynamic allocation and/or semi-persistent transmission).

Referring to FIG. 8, in operation 407, a transmitting UE 401 camping on a cell (e.g., at operation 405) may receive a sidelink SIB from a base station 403. In operation 409, a receiving UE 402 may receive the sidelink SIB from the base station 403. The receiving UE 402 refers to a UE that receives data transmitted by the transmitting UE 401. The sidelink SIB may be transmitted periodically or on demand. The sidelink SIB may include at least one of sidelink resource pool information for sidelink communication, parameter configuration information for a sensing operation, information for configuring sidelink synchronization, or carrier information for sidelink communication operating at different frequencies. Although operation 407 and operation 409 have been illustrated sequentially, which is for convenience of explanation, and operation 407 and operation 409 may be performed in parallel.

In operation 413, when data traffic for sidelink communication is generated in the transmitting UE 401, the transmitting UE 401 may establish an RRC connection with the base station 403. The RRC connection between the transmitting UE 401 and the base station 403 may be referred to as Uu-RRC. The Uu-RRC connection may be established before the data traffic of the transmitting UE 401 is generated. In mode 1, the transmitting UE 401 may perform transmission to the receiving UE 402 through a sidelink in a state in which the Uu-RRC connection is established between the base station 403 and the receiving UE 402. Further, in mode 1, the transmitting UE 401 may perform transmission to the receiving UE 402 through the sidelink even in a state in which the Uu-RRC connection is not established between the base station 403 and the receiving UE 402.

In operation 415, the transmitting UE 401 may request a transmission resource for performing sidelink communication with the receiving UE 402 to the base station 403. The transmitting UE 401 may request the transmission resource for the sidelink to the base station 403 by using at least one of a physical uplink control channel (PUCCH), an RRC message, or a medium access control (MAC) control element (MAC CE). For example, when the MAC CE is used, the MAC CE may be a MAC CE about a buffer status report with a new format including at least one of an indicator indicating a buffer status report (BSR) for sidelink communication and information about the size of data stored in a buffer for device-to-device (D2D) communication (or V2X communication). The MAC CE may be referred to as a sidelink BSR MAC CE. When the PUCCH is used, the transmitting UE 401 may request the sidelink resource through a bit of a scheduling request (SR) transmitted through the PUCCH.

In operation 417, the base station 403 may transmit downlink control information (DCI) to the transmitting UE 401 through a physical downlink control channel (PDCCH). That is, the base station 403 may indicate final scheduling for sidelink communication with the receiving UE 402 to the transmitting UE 401. Specifically, the base station 403 may allocate a sidelink transmission resource to the transmitting UE 401 according to at least one of a dynamic grant (DG) method or a configured grant (CG) method.

In the dynamic grant (DG) method, the base station 403 may allocate a resource for one transport block (TB) transmission by transmitting DCI to the transmitting UE 401. Sidelink scheduling information included in the DCI may include a parameter related to an initial transmission occasion and/or a transmission occasion of retransmission and a parameter related to a frequency allocation location information field. The DCI for the dynamic grant method may be subjected to cyclic redundancy check (CRC) scrambling, based on a sidelink-v2x-radio network temporary identifier (SL-V-RNTI) to indicate that a transmission resource allocation method is the dynamic grant method.

In the configured grant (CG) method, a resource for transmitting a plurality of TBs may be periodically allocated by configuring a semi-persistent scheduling (SPS) interval in the Uu-RRC. In this case, the base station 403 may allocate the resource for the plurality of TBs by transmitting DCI to the transmitting UE 401. Sidelink scheduling information included in the DCI may include a parameter related to an initial transmission occasion and/or a transmission occasion of retransmission and a parameter related to a frequency allocation location information field. In the configured grant method, the initial transmission occasion and/or the transmission occasion of retransmission and a frequency allocation location may be determined according to the transmitted DCI, and the resource may be repeated at the SPS interval. The DCI for the configured grant method may be subjected to CRC scrambling based on an SL-SPS-V-RNTI to indicate that a transmission resource allocation method is the configured grant method. The configured grant method may be classified into type-1 CG and type-2 CG. In the type-2 CG, the base station 403 may activate and/or deactivate a resource configured by a configured grant through the DCI. Therefore, in mode 1, the base station 403 may indicate final scheduling for sidelink communication with the receiving UE 402 to the transmitting UE 401 by transmitting the DCI through the PDCCH.

When broadcast transmission is performed between the UEs 401 and 402, the transmitting UE 401 may broadcast sidelink control information (SCI) to the receiving UE 402 through a PSCCH without additional sidelink RRC configuration (operation 411), in operation 419. In operation 421, the transmitting UE 401 may broadcast data to the receiving UE 402 through a PSSCH.

When unicast or groupcast transmission is performed between the UEs 401 and 402, the transmitting UE 401 may perform a one-to-one RRC connection with other UEs (e.g., the receiving UE 402), in operation 411. In this case, the RRC connection between the UEs 401 and 402 may be referred to as PC5-RRC to be distinguished from the Uu-RRC. In groupcast transmission, a PC5-RRC connection may be separately established between UEs within a group. Although FIG. 8 shows that the PC5-RRC connection (operation 411) is performed after transmission of the sidelink SIB (operation 407 and operation 409), the PC5-RRC connection (operation 411) may be performed before the transmission of the sidelink SIB or before broadcast of the SCI (operation 419). When an RRC connection between the UEs is required, a sidelink PC5-RRC connection may be performed, and the transmitting UE 401 may transmit the SCI to the receiving UE 402 through the PSCCH by unicast or groupcast, in operation 419. Here, groupcast transmission of the SCI may be understood as group SCI. In operation 421, the transmitting UE 401 may transmit the data to the receiving UE 402 through the PSSCH by unicast or groupcast. In mode 1, the transmitting UE 401 may identify the sidelink scheduling information included in the DCI received from the base station 403, and may perform scheduling for the sidelink, based on the sidelink scheduling information. The SCI may include the following scheduling information.
Field related to transmission occasion of initial transmission and retransmission and frequency allocation location information
New data indicator (NDI) field
Redundancy version (RV) field
Information field for indicating reservation interval

In the information field for indicating the reservation interval, the interval between TBs may be indicated as one fixed value when a resource for a plurality of TBs (i.e., a plurality of MAC protocol data units (PDUs)) is selected, and “0” may be indicated as the value of the interval between TBs when a resource for one TB is selected.

In operation 423, the receiving UE 402 transmits whether demodulation/decoding of the data received in operation 421 has succeeded to the transmitting UE 401 through first HARQ feedback information. The first HARQ feedback information includes ACK (success) or NACK (failure) information, and the receiving UE 402 transmits the first HARQ feedback information to the transmitting UE 401 through a PSFCH. In operation 425, the transmitting UE 401 transmits a transmission result to the base station 403 through second HARQ feedback information, based on the first HARQ feedback information received from the receiving UE 402. The second HARQ feedback is transmitted to the base station through a PUCCH. The second HARQ feedback information may or may not be the same as the first HARQ feedback information. Further, the second HARQ feedback information may include a plurality of pieces of first HARQ feedback information. The plurality of pieces of first HARQ feedback information may include a plurality of pieces of HARQ feedback information received from one receiving UE, or may include one piece or a plurality of pieces of HARQ feedback information received from a plurality of UEs. Through the second HARQ feedback information, the base station may allocate a resource for retransmission or a resource for new transmission to the transmitting UE 401, or may stop resource allocation when there is no more transmission resource to be allocated to the transmitting UE 401. A transmission resource for the PUCCH in operation 425 may be determined by the DCI that the base station transmits to the transmitting UE via the PDCCH, in operation 417. A transmission resource for the PSFCH in operation 423 may be determined by the SCI of the PSCCH, in operation 419, or be determined by a transmission resource area in which the PSSCH in operation 421 is transmitted and received.

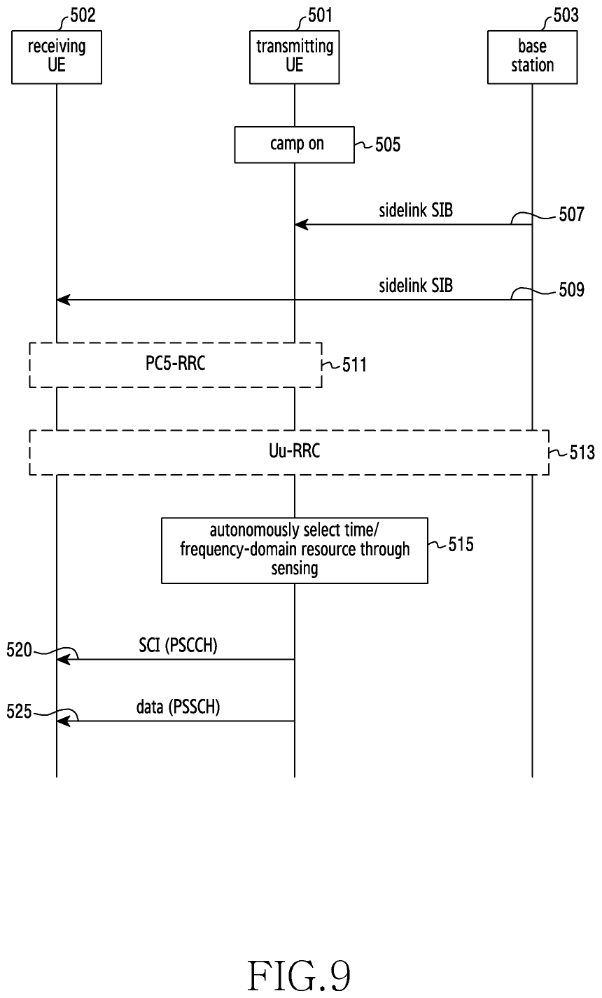

FIG. 9 illustrates another example of signal flow for allocating a transmission resource of a sidelink in a wireless communication system according to an embodiment of the disclosure. FIG. 9 illustrates a signal exchange between a transmitting UE 501, a receiving UE 502, and a base station 503.

As described below, a mode in which a UE directly allocates a transmission resource of a sidelink through sensing in the sidelink may be referred to as mode 2. Mode 2 may also be referred to as UE autonomous resource selection. Specifically, according to mode 2, a base station 503 provides a sidelink transmission/reception resource pool for the sidelink to the UE through system information or an RRC message (e.g., an RRCReconfiguration message or a PC5 RRC message), and the transmitting UE 501 selects a resource pool and a resource according to a set rule. Unlike mode 1 in which the base station is directly involved in resource allocation illustrated in FIG. 8, mode 2 illustrated in FIG. 9 allows the transmitting UE 501 to autonomously select a resource and transmit data, based on the resource pool received in advance through the system information.

Referring to FIG. 9, in operation 507, a camping-on (operation 505) of a transmitting UE 501 may receive a sidelink SIB from a base station 503. In operation 509, a receiving UE 502 may receive the sidelink SIB from the base station 503. The receiving UE 502 refers to a UE that receives data transmitted by the transmitting UE 501. The sidelink SIB may be transmitted periodically or on demand. The sidelink SIB may include at least one of sidelink resource pool information for sidelink communication, parameter configuration information for a sensing operation, information for configuring sidelink synchronization, or carrier information for sidelink communication operating at different frequencies. Although operation 507 and operation 509 have been illustrated sequentially, which is for convenience of explanation, and operation 507 and operation 509 may be performed in parallel.

The base station 503 and the transmitting UE 501 operate in an RRC-connected state in FIG. 8 described above, whereas the base station 503 and the transmitting UE 501 may operate regardless of whether the base station 503 and the transmitting UE 501 are RRC-connected, in operation 513 in FIG. 9. That is, even in an idle mode in operation 513 in which the base station 503 and the transmitting UE 501 are RRC-disconnected, sidelink communication based on mode 2 may be performed. Further, even in the RRC-connected state, the base station 503 may operate to enable the transmitting UE 501 to autonomously select a transmission resource instead of being directly involved in resource allocation. In this case, an RRC connection between the transmitting UE 501 and the base station 503 may be referred to as Uu-RRC.

In operation 515, when data traffic for sidelink communication is generated in the transmitting UE 501, the transmitting UE 501 may receive a configured resource pool through system information received from the base station 503, and may autonomously select time and frequency-domain resources through sensing within the configured resource pool.

When broadcast transmission is performed between the UEs 501 and 502, in operation 520, the transmitting UE 501 may broadcast SCI to the receiving UE 502 through a PSCCH without additional sidelink RRC configuration (operation 513), in operation 520. Further, in operation 525, the transmitting UE 401 may broadcast data to the receiving UE 402 through a PSSCH.

When unicast or groupcast transmission is performed between the UEs 501 and 502, the transmitting UE 501 may perform a one-to-one RRC connection with other UEs (e.g., the receiving UE 502) in operation 511. In this case, the RRC connection between the UEs 501 and 502 may be referred to as PC5-RRC to be distinguished from the Uu-RRC. In groupcast transmission, a PC5-RRC connection may be separately established between UEs within a group. Although FIG. 9 shows that the PC5-RRC connection (operation 511) is performed after transmission of the sidelink SIB (operation 507 and operation 509), the PC5-RRC connection (operation 511) may be performed before the transmission of the sidelink SIB or before transmission of the SCI (operation 520). When an RRC connection between the UEs is required, a sidelink PC5-RRC connection may be performed, and the transmitting UE 501 may transmit the SCI to the receiving UE 502 through the PSCCH by unicast or groupcast, in operation 520. Here, groupcast transmission of the SCI may be understood as group SCI. In operation 525, the transmitting UE 501 may transmit the data to the receiving UE 502 through the PSSCH by unicast or groupcast. In mode 2, the transmitting UE 501 may perform sensing and a transmission resource selection operation, thereby autonomously performing scheduling for the sidelink. The SCI may include the following scheduling information.
Field related to transmission occasion of initial transmission and retransmission and frequency allocation location information
New data indicator (NDI) field
Redundancy version (RV) field
Information field for indicating reservation interval

In the information field for indicating the reservation interval, the interval between TBs may be indicated as one fixed value when a resource for a plurality of TBs (i.e., a plurality of PAC PDUs) is selected, and the value of the interval between TBs may be indicated as “0” when a resource for one TB is selected.

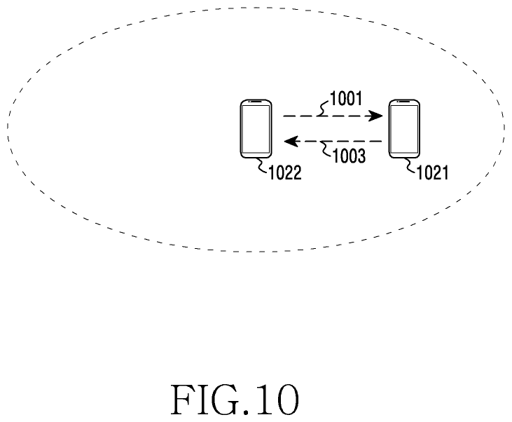

FIG. 10 illustrates an example illustrating a scenario in which a signal is normally received or power ramping is required in a wireless communication system according to an embodiment of the disclosure.

Referring to FIG. 10, in an embodiment, in a state in which a first UE 1021 and a second UE 1022 are out-of-coverage (OOC), the second UE 1022 may transmit a first signal 1001, based on broadcast communication. The first UE 1021 may receive the first signal 1001. For example, when the first UE 1021 and the second UE 1022 are in a situation corresponding to the example illustrated in FIG. 3, the second UE 1022 may transmit the first signal 1001, based on mode 2. The first signal 1001 may include frequency resource information, time resource information, and status information. The frequency resource information may include identification information for identifying a frequency resource used by the second UE 1022 to transmit a signal. For example, the frequency resource information may include an index value for identifying the frequency resource. The time resource information may include identification information for identifying time when the second UE 1022 transmits a signal. For example, the time information of the first signal 1001 may include an index value for a time resource set that may specify a time interval at which the second UE 1022 transmits a signal. The status information may include information for identifying a purpose of the second UE 1022 transmitting the first signal 1001. For example, since the second UE 1022 is broadcasting the first signal 1001 to transmit data that the second UE 1022 wants to transmit to another UE, the status information may be a first value (e.g., a default value of 00). Although the disclosure shows an example in which the status information is represented by two bits to specify four states, the status information may be represented by three or more bits to specify a larger number of states.

In an embodiment, the first signal 1001 may include identification information about the second UE 1022 transmitting the signal. The first UE 1021 may recognize the identification degree of the second UE 1022, based on the received signal. When the identification information is not identified from the received signal, the first UE 1021 may recognize that there is no signal.

In an embodiment, the first UE 1021 may perform decoding on the received first signal 1001. When the identification information about the second UE 1022 is recognized from the first signal 1001 but the decoding fails, the first UE 1021 needs to request power ramping to the second UE 1022 having transmitted the first signal 1001. The first UE 1021 may transmit a third signal 1003 for requesting power ramping to the second UE 1022, based on a broadcast mode. The third signal 1003 may include frequency resource information, time resource information, and status information. The status information included in the third signal 1003 may include information indicating a state of requesting power ramping. For example, the status information included in the third signal 1003 may be a second value (e.g., 01). The first UE 1021 may determine the frequency resource information and the time resource information to be transmitted through the third signal 1003, based on the frequency resource information and the time resource information included in the first signal 1001. By the first UE 1021 transmitting the frequency resource information and the time resource information included in the first signal 1001, the second UE 1022 receiving the third signal 1003 may indirectly recognize that a UE requested to ramp up power is the second UE 1022.

In an embodiment, the second UE 1022 may receive the third signal 1003. The second UE 1022 may identify a status information field among data included in the third signal 1003. When the status information is a default value (e.g., the first value of 00) indicating a default state in which the first UE 1021 broadcasts data, the second UE 1022 may broadcast data to transmit without a separate configuration change. When the status information is the second value, the second UE 1022 may compare the frequency resource information and the time information (hereinafter, “feedback resource information”) included in the third signal 1003 with a frequency resource and a time resource (e.g., the frequency resource information and the time resource information included in the first signal 1001) (hereinafter, “transmitting UE resource information”) used by the second UE 1022 to transmit a signal. When the received feedback resource information and the transmitting UE resource information of the second UE 1022 match, the second UE 1022 may broadcast a fourth signal by ramping up power for signal transmission.

In the disclosure, the frequency resource information and the time resource information included in the third signal 1003 are information for enabling the UE receiving the third signal 1003 to indirectly recognize whether a request included in the third signal 1003 is intended for the UE, and may thus be referred to as indirect side information. The UE may select a resource (frequency and time) considering the amount of information to be transmitted. Accordingly, each UE may autonomously select a frequency resource set index and a time interval set index to be used by each UE and broadcast a signal. In an embodiment, since characteristics of broadcast communication make it impossible to designate a receiver, a field including indirect side information may be included in a broadcast signal so that UEs transmitting a signal may be separately controlled to facilitate a communication schedule. Although the disclosure shows examples in which frequency resource information and time resource information are represented by three bits and the status information is represented by two bits, which is only for illustration, other forms (e.g., frequency resource information, time resource information, and status information represented by a larger number of bits) may also be used as indirect side information depending on a UE that needs to be specified and a state.

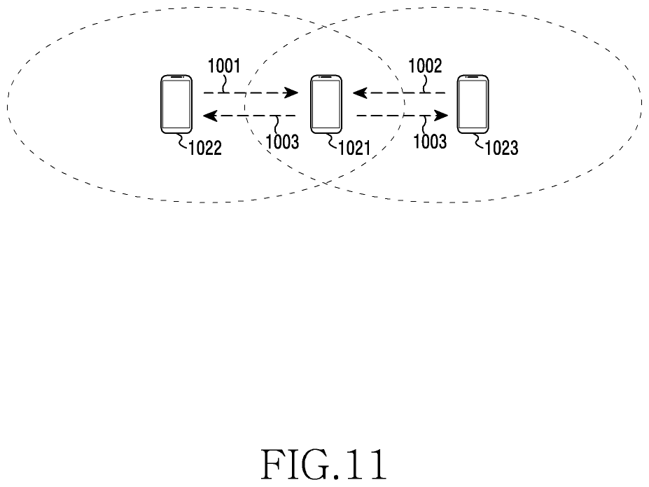

FIG. 11 illustrates an example of a scenario in which a collision may occur in a wireless communication system according to an embodiment of the disclosure.

Referring to FIG. 11, in an embodiment, in a state in which a first UE 1021, a second UE 1022, and a third UE 1023 are out-of-coverage, the second UE 1022 may transmit a first signal 1001, based on broadcast communication. The third UE 1023 may transmit a second signal 1002, based on broadcast communication. The first UE 1021 may receive the first signal 1001 and the second signal 1002. For example, when the first UE 1021 and the second UE 1022 are in a situation corresponding to the example illustrated in FIG. 3 and the first UE 1021 and the third UE 1023 are also in the situation corresponding to the example illustrated in FIG. 3, the second UE 1022 and the third UE 1023 may transmit the first signal 1001 and the second signal 1002, respectively. Each of the first signal 1001 and the second signal 1002 may include frequency resource information, time resource information, and status information. The frequency resource information (hereinafter, “first frequency resource information”) included in the first signal 1001 may include identification information for identifying a frequency resource used by the second UE 1022 to transmit a signal. The frequency resource information (hereinafter, “second frequency resource information”) included in the second signal 1002 may include identification information for identifying a frequency resource used by the third UE 1023 to transmit a signal. The time resource information (hereinafter, “first time resource information”) included in the first signal 1001 may include identification information for identifying time (e.g., a transmission time interval) when the second UE 1022 transmits a signal. The time resource information (hereinafter, “second time resource information”) included in the second signal 1002 may include identification information for identifying time (e.g., a transmission time interval) when the third UE 1023 transmits a signal.

In an embodiment, the first UE 1021 may decode the first signal 1001 and the second signal 1002 to obtain the first frequency resource information, the second frequency resource information, the first time resource information, and the second time resource information. The first UE 1021 may determine whether signal transmission of the second UE 1022 and signal transmission of the third UE 1023 collide, based on the first frequency resource information, the second frequency resource information, the first time resource information, and the second time resource information. For example, the first UE 1021 may compare the first frequency resource information and the second frequency resource information to determine whether signal-transmitting frequency bands overlap. In addition, for example, the first UE 1021 may compare the first time resource information and the second time resource information to determine whether the time in which the second UE 1022 transmits a signal overlaps, based on a first time interval at which the second UE 1022 transmits a signal and a second time interval at which the third UE 1023 transmits a signal. The first UE 1021 may determine that a collision occurs when the frequency bands and the signal transmission times overlap.

In an embodiment, when determining that a collision occurs, the first UE 1021 may compare the first time resource information and the second time resource information. The first UE 1021 may determine frequency resource information, time resource information, and status information to be included in a third signal 1003, based on whether the first time resource information and the second time resource information match.

In an embodiment, when the first time resource information and the second time resource information do not match, the first UE 1021 may designate one of the UEs (e.g., the second UE 1022 and the third UE 1023) having transmitted the signals. For example, when there is a priority for designating a UE, the first UE 1021 may select a UE with a higher priority. For example, when there is no priority, the first UE 1021 may select a UE, based on another criterion. For example, the first UE 1021 may designate a UE having great data to be transmitted among the second UE 1022 and the third UE 1023. However, the disclosure is not limited thereto.

In an embodiment, the first UE 1021 may transmit the third signal 1003 including frequency resource information and time resource information included in a signal (e.g., the first signal 1001 when the second UE 1022 is selected) transmitted by the selected UE. Here, the status information included in the third signal 1003 may be a third value (e.g., 10) for requesting a UE other than the designated UE to transmit a signal based on a different frequency resource or a different time resource. Each of the second UE 1022 and the third UE 1023 may receive the third signal 1003. The second UE 1022 and the third UE 1023 may decode the third signal 1003 to obtain the frequency resource information (hereinafter, “third frequency resource information”), the time resource information (hereinafter, “third time resource information”), and the status information. When the status information is the third value, the second UE 1022 and the third UE 1023 may compare the frequency resource information and the time resource information in use with the third frequency resource information (e.g., 010) and the third time resource information (e.g., 010). When the first frequency resource information (e.g., 010) and the first time resource information (e.g., 010) correspond to the third frequency resource information (e.g., 010) and the third time resource information (e.g., 010), the second UE 1022 may broadcast a signal while maintaining a frequency resource and a time resource for transmitting a signal. When the second time resource information and the third time resource information are different, the third UE 1023, which has transmitted the second signal 1002 based on the second frequency resource information (e.g., 010) and the second time resource information (e.g., 100), may stop transmitting a signal. The third UE 1023 may retransmit a signal by changing at least one of a frequency resource or a time resource.

In an embodiment, when the first time resource information and the second time resource information match, the first UE 1021 may broadcast the third signal 1003 including the third frequency resource information, the third time resource information, and the status information. The status information may be a fourth value (e.g., 11) for requesting reconfiguration to each UE. The third frequency resource information may be the same as the first frequency resource information included in the first signal 1001 and the second frequency resource information included in the second signal 1002. For example, the first frequency resource information, the second frequency resource information, and the third frequency resource information may be an index value (e.g., 010) indicating the same frequency resource. The third time resource information may be the same as the first time resource information included in the first signal 1001 and the second time resource information included in the second signal 1002. For example, the first time resource information, the second time resource information, and the third time resource information may be an index value (e.g., 010) indicating the same time resource. The second UE 1022 and the third UE 1023 may each receive the third signal 1003. The second UE 1022 and the third UE 1023 may decode the third signal 1003 to obtain the third frequency resource information, the third time resource information, and the status information. When the status information is the fourth value, the second UE 1022 and the third UE 1023 that have received the third signal 1003 may stop transmitting a signal. The second UE 1022 and the third UE 1023 may each configure a new frequency resource and a new time resource. The second UE 1022 and the third UE 1023 may each retransmit a signal, based on the new frequency resource and the new time resource.

Although FIG. 11 illustrates a case in which the first UE 1021 receives signals (first signal 1001 and second signal 1002) respectively from the second UE 1022 and the third UE 1023, the second UE 1022 and the third UE 1023 are for illustration to explain that signals are received from a plurality of UEs. Even when the first UE 1021 receives signals respectively from three or more UEs, the first UE 1021 may apply the same process to the signals received from the UEs.

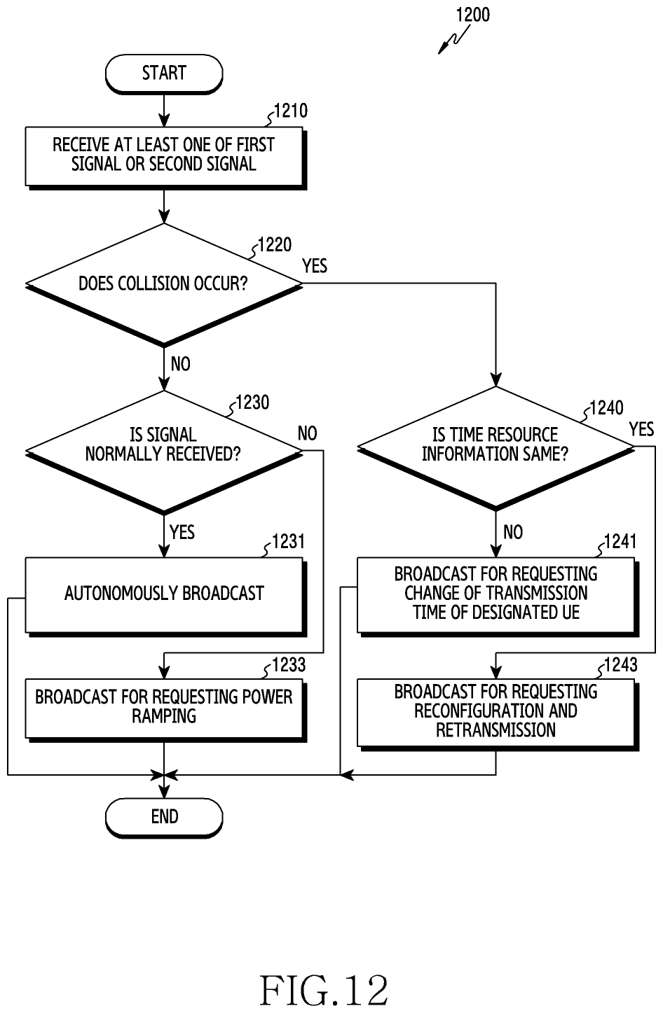

FIG. 12 is a flowchart 1200 illustrating a process in which a first UE (e.g., the first UE 1021 of FIGS. 10 and 11) operates in a wireless communication system according to an embodiment of the disclosure.

According to an embodiment, in operation 1210, the first UE 1021 may receive at least one of a first signal 1001 or a second signal 1002 as described in FIG. 10 or FIG. 11. The first signal 1001 and the second signal 1002 may be signals broadcast by different UEs (e.g., the second UE 1022 and the third UE 1023 of FIG. 11).

Referring to FIG. 12, in operation 1220, a first UE 1021 may determine whether a collision occurs in signal transmissions of the different UEs, based on at least one of a first signal 1001 or a second signal 1002. When only a signal (e.g., the first signal 1001 or the second signal 1002) transmitted from one UE is received, the first UE 1021 may not determine that a collision occurs. When signals (e.g., the first signal 1001 and the second signal 1002) transmitted from a plurality of UEs are received, the first UE 1021 may determine whether a collision occurs, based on frequency resource information and time resource information obtained from the received signals.

In operation 1230, the first UE 1021 may determine whether the received signal is normally received. For example, the first UE 1021 may attempt to decode the received signal, and may determine that the signal is normally received when successfully decoding the signal. For example, when failing to decode the signal, the first UE 1021 may determine that the signal is not normally received.

When determining that the signal is normally received in operation 1230, the first UE 1021 may perform broadcast communication to transmit data that the first UE wants to transmit to another UE, in operation 1231. Frequency resource information and time resource information included in a signal transmitted in operation 1231 may include values indicating a frequency resource and a time resource used by the first UE 1021 to transmit a signal. Status information included in the signal transmitted in operation 1231 may include a first value indicating that the first UE 1021 is transmitting data that the first UE wants to transmit to another UE.

When determining that the signal fails to be normally received in operation 1230, the first UE 1021 may broadcast a signal (e.g., a third signal 1003) for requesting power ramping, in operation 1233. Here, the first UE 1021 may obtain frequency resource information and time resource information from the received signal. When the frequency resource information and the time resource information are not identified from the received signal, the first UE 1021 may determine that there is no signal. Frequency resource information and time resource information included in the signal transmitted in operation 1233 may be the same as the frequency resource information and the time resource information identified from the received signal. Status information included in the signal transmitted in operation 1233 may include a second value indicating that power ramping is requested.

When determining that a collision occurs in operation 1220, the first UE 1021 may compare pieces of time resource information (e.g., first time resource information of the first signal 1001 and second time resource information of the second signal 1002) included in the received signals (e.g., the first signal 1001 and the second signal 1002), in operation 1240.

When the pieces of time resource information included in the received signals are different from each other, the first UE 1021 may designate one of the UEs having transmitted the signals. In operation 1241, the first UE 1021 may broadcast a signal (e.g., a third signal 1003) including frequency resource information and time resource information corresponding to the designated UE. The frequency resource information and the time resource information included in the signal transmitted in operation 1241 may be the same as frequency resource information and time resource information included in the signal transmitted by the selected UE. Status information included in the signal transmitted in operation 1241 may be a third value for requesting a UE other than the designated UE to transmit a signal based on a different frequency resource or a different time resource.

When the pieces of time resource information in the received signals are the same, the first UE 1021 may broadcast a signal (e.g., a third signal 1003) for requesting reconfiguration and retransmission to each UE, in operation 1243. Frequency resource information and time resource information included in the signal transmitted in operation 1243 may be the same as the frequency resource information and the time resource information included in the received signals. Status information included in the signal transmitted in operation 1243 may be a fourth value indicating that reconfiguration is requested to each UE.

FIG. 12 illustrates a process in which the first UE 1021 broadcasts feedback information, based on four types of status information, but the first UE 1021 may classify a state in which a signal is broadcast into a larger number of types and may broadcast a third signal 1003 including different status information in each state in an embodiment.

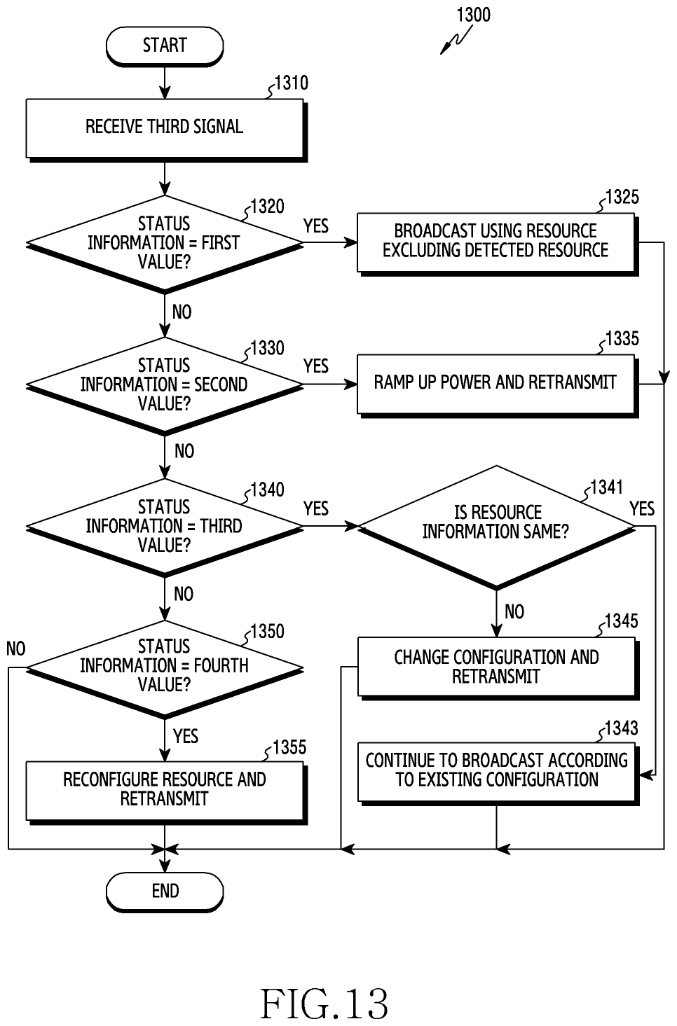

FIG. 13 is a flowchart 1300 illustrating a process in which a second UE (e.g., the second UE 1022 of FIGS. 10 and 11) operates in a wireless communication system according to an embodiment of the disclosure. The flowchart 1300 illustrated in FIG. 13 may be performed in the same manner in a third UE (e.g., the third UE 1023 of FIG. 11).

Referring to FIG. 13, according to an embodiment, in operation 1310, the second UE 1022 may receive a third signal (e.g., the third signal 1003 of FIG. 11) broadcast by a first UE 1021. The second UE 1022 may decode the third signal 1003 to obtain frequency resource information, time resource information, and status information.

In operation 1320, the second UE 1022 may determine whether the status information is a first value (e.g., 00). When the status information obtained from the third signal 1003 is the first value, the second UE 1022 may perform operation 1325 of broadcasting data that the second UE wants to transmit. In operation 1325, the second UE 1022 may broadcast the data by using a resource excluding a resource detected from the third signal 1003 to avoid a collision with the signal transmitted by the first UE 1021. For example, the second UE 1022 may transmit a signal by using a frequency resource different from the frequency resource information included in the third signal 1003. Alternatively, for example, the second UE 1022 may transmit a signal, based on a time interval not causing a collision with a time interval corresponding to the time resource information included in the third signal.

In operation 1330, the second UE 1022 may determine whether the status information is a second value (e.g., 01) indicating that power ramping is requested. When the status information is the second value, the second UE 1022 may compare the frequency resource information and the time resource information obtained from the third signal 1003 with a frequency resource and a time resource configured for the second UE 1022 to transmit a signal. When the frequency resource information and the time resource information obtained from the third signal 1003 match the frequency resource and the time resource configured for the second UE 1022, the second UE 1022 may perform operation 1335 of retransmitting a first signal 1001 with higher power. Although not shown in FIG. 13, when the frequency resource information and the time resource information obtained from the third signal 1003 are different from the frequency resource and the time resource configured for the second UE 1022, the second UE 1022 may be configured to perform operation 1325.

In operation 1340, the second UE 1022 may determine whether the status information is a third value (e.g., 10) for requesting for a UE other than a designated UE to transmit a signal based on a different frequency resource or a different resource. When the status information is the third value, the second UE 1022 may compare the frequency resource information and the time resource information obtained from the third signal 1003 with the frequency resource and the time resource configured for the second UE 1022 to transmit a signal, in operation 1341. When the frequency resource information and the time resource information obtained from the third signal 1003 match the frequency resource and the time resource configured for the second UE 1022, the second UE 1022 may continue broadcast communication according to the existing configuration of the frequency resource and the time resource, in operation 1343. When the frequency resource information and the time resource information obtained from the third signal 1003 are different from the frequency resource and the time resource configured for the second UE 1022, the second UE 1022 may stop transmitting a signal in operation 1345. In operation 1345, the second UE 1022 may configure a frequency resource different from a frequency band indicated by the frequency resource, based on the frequency resource information and the time resource information obtained from the third signal 1003, or may configure a time resource that does not cause a collision with the time interval indicated by the time resource information. In operation 1345, the second UE 1022 may perform retransmission, based on the configured frequency resource and time resource.

In operation 1350, the second UE 1022 may determine whether the status information is a fourth value (e.g., 11) indicating that resource reconfiguration and retransmission are requested to each UE. When the status information is the fourth value, the second UE 1022 may perform resource selection again, in operation 1355. In operation 1355, the second UE 1022 may retransmit the signal, based on a reconfigured resource. When the status information included in the third signal 1003 does not correspond to any of predetermined values, the third signal 1003 may be processed as no signal or as an error in signal reception. Alternatively, operation 1350 may be omitted, and operation 1355 may be performed when the status information is not the third value in operation 1340.

Although operations 1320, 1330, 1340, and 1350 are sequentially illustrated for convenience of explanation, the disclosure is not limited thereto. Operations 1320, 1330, 1340, and 1350 may also be configured as a single operation in which operation 1325 is performed when the status information is the first value, operation 1335 is performed when the status information is the second value, operation 1341 is performed when the status information is the third value, and operation 1355 is performed when the status information is the fourth value.

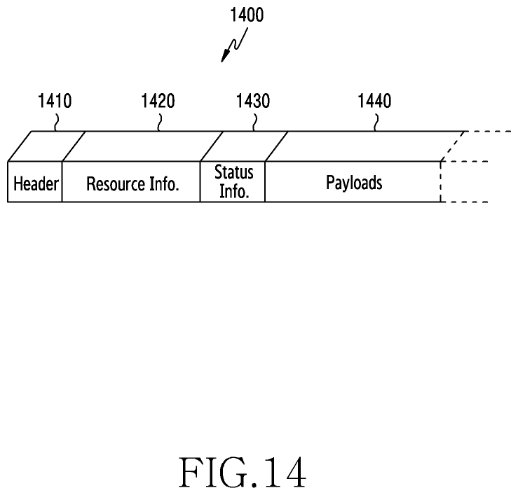

FIG. 14 is a diagram schematically illustrating data included in a signal broadcasted in a wireless communication system according to an embodiment of the disclosure.

In an embodiment, data included in signals (e.g., a first signal 1001, a second signal 1002, and a third signal 1003) transmitted by UEs (e.g., a first UE 1021, a second UE 1022, and a third UE 1023) based on mode 2 may include fields of data 1400 illustrated in FIG. 14.

Referring to FIG. 14, in an embodiment, the signals 1001, 1002, and 1003 transmitted by the UEs 1021, 1022, and 1023 may include a header field 1410, a resource information field 1420, a status information field 1430, and payloads 1440.

In an embodiment, the resource information field 1420 may include frequency resource information and time resource information. The frequency resource information may include information for identifying a frequency band used for transmitting a signal. For example, the frequency resource information may be an index value (e.g., 001, 010, 011, 100, or the like) corresponding to a specific frequency resource set. The time resource information may include information for identifying a time interval for transmitting a signal. For example, the time resource information may be an index value (e.g., 001, 010, 011, 100, or the like) corresponding to a specific time interval for transmitting a signal.

In an embodiment, the status information field 1430 may include status information indicating the status of a UE transmitting the data 1400. For example, when the status of a UE is classified into four types in the wireless communication system, the status information may be any one of 00, 01, 10, or 11.

In an embodiment, the payloads 1440 may include data that a UE transmitting a signal wants to transmit to another UE. For example, the payloads 1440 may include a warning message or information for platooning.

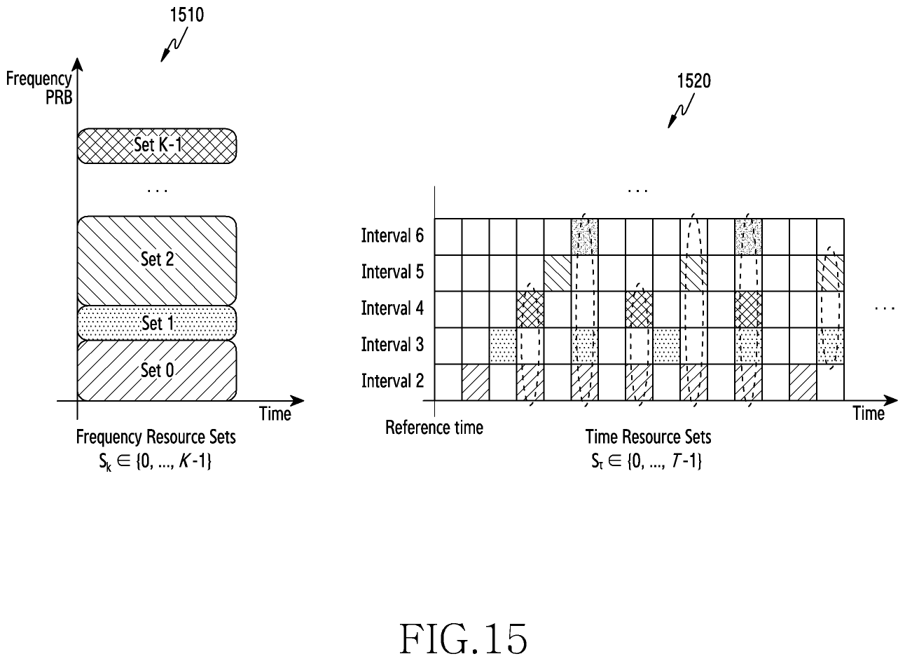

FIG. 15 illustrates an example of a frequency resource set and a time resource set of a sidelink in a wireless communication system according to an embodiment of the disclosure.

Referring to FIG. 15, in the wireless communication system according to an embodiment, each UE (e.g., a first UE 1021, a second UE 1022, and a third UE 1023) may select a frequency resource and a time resource from among frequency resource sets 1510 and time resource sets 1520 to transmit a signal. Referring to FIG. 15, in the wireless communication system, each UE may select any one frequency resource from among K frequency resource sets 1510. In the wireless communication system, each UE may select any one from among T time resource sets 1520 and transmit a signal of a frequency corresponding to the selected frequency resource at a time interval corresponding to the selected time resource set.

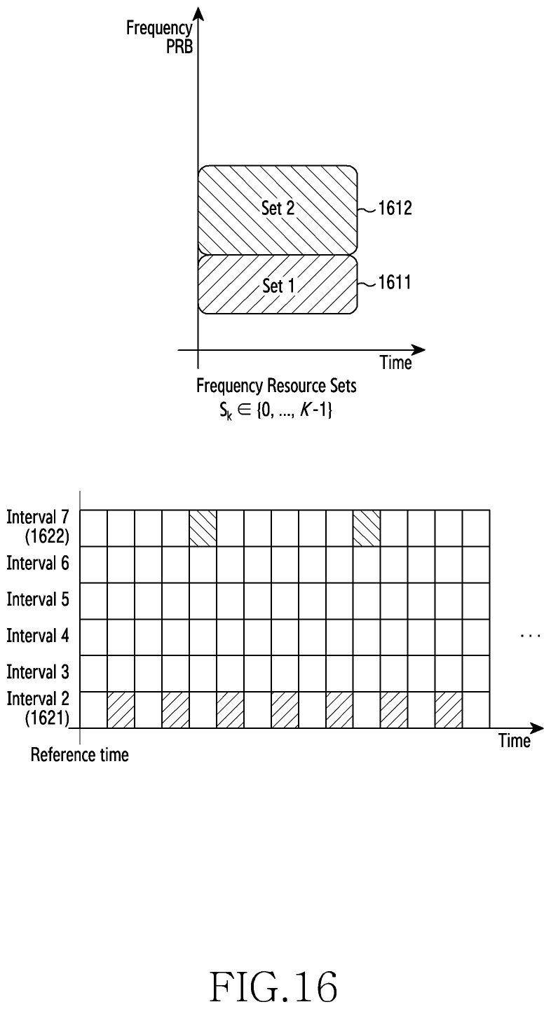

FIG. 16 illustrates an example in which no collision occurs in a sidelink of a wireless communication system according to an embodiment of the disclosure.

In the wireless communication system, when UEs broadcast signals, based on different frequency resources, the signals may be separated by frequency band, and thus a collision may not occur.

Referring to FIG. 16, when a second UE 1022 transmits a first signal 1001, based on a first frequency resource set 1611 and a third UE 1023 transmits a second signal 1002, based on a second frequency resource set 1612, a collision may not occur.

In the wireless communication system, when time slots in which UEs transmit signals do not overlap, a collision may not occur. Referring to FIG. 16, when the second UE 1022 transmits the first signal 1001, based on a first time interval 1621 and the third UE 1023 transmits the signal 1002, based on a second time interval 1622, a collision may not occur.

In an embodiment, when no collision occurs, the first UE 1021 may transmit a third signal 1003 having a first value (e.g., 00) indicating a state of transmitting data that the first UE wants to transmit or a second value (e.g., 01) indicating a state of requesting power ramping as status information. A UE (e.g., the second UE 1022) that receives the third signal 1003 having the second value as the status information may retransmit a signal with higher power than when a target indicated by the frequency resource information and the time resource information included in the third signal 1003 is the UE.

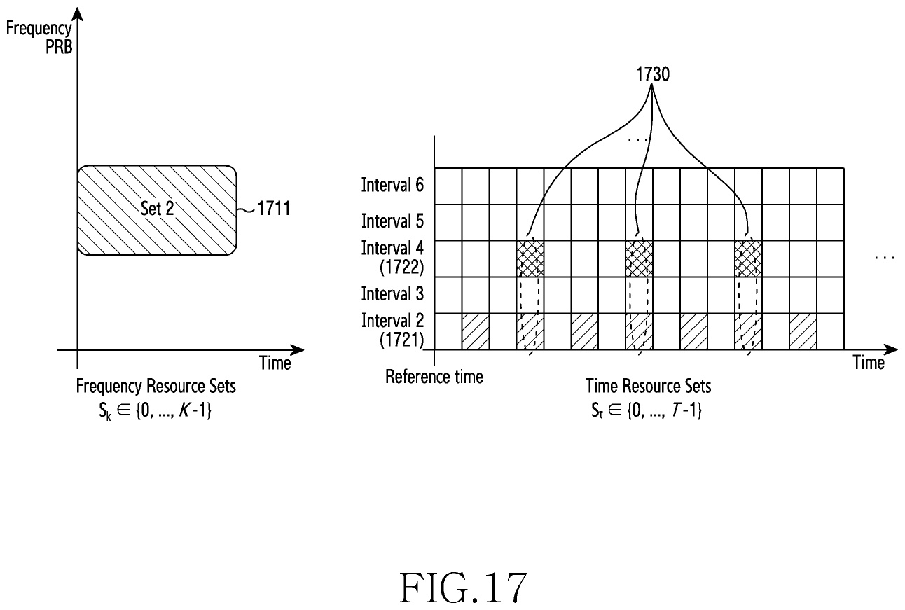

FIG. 17 illustrates an example in which a collision occurs in a sidelink of a wireless communication system according to an embodiment of the disclosure. In particular, FIG. 17 illustrates an example in which a collision occurs in a sidelink of a wireless communication system but UEs use different time resources according to an embodiment.

In the wireless communication system, when time slots in which UEs transmit signals by using the same frequency resource overlap, a collision may occur.

Referring to FIG. 17, a second UE 1022 and a third UE 1023 may transmit signals, based on the same frequency resource set 1711. The second UE 1022 transmits a signal, based on a first time interval 1721, and the third UE 1023 transmits a signal, based on a second time interval 1722 that is different from the first time interval 1721, but collision instances 1730 in which time slots overlap may occur.

In this case, a first UE 1021 according to an embodiment may designate one UE among the UEs 1022 and 1023 having transmitted the received signals. The first UE 1021 may transmit a third signal 1003 including frequency resource information and time resource information corresponding to the designated UE (e.g., the second UE 1022) and a third value (e.g., 10) for requesting a UE (e.g., the third UE 1023) other than the designated UE to transmit a signal through a different resource. A UE (e.g., the second UE 1022 and the third UE 1023) receiving the third signal 1003 having the third value as status information may reconfigure a resource to retransmit a signal when a target indicated by the frequency resource information and the time resource information included in the third signal 1003 is not the UE.

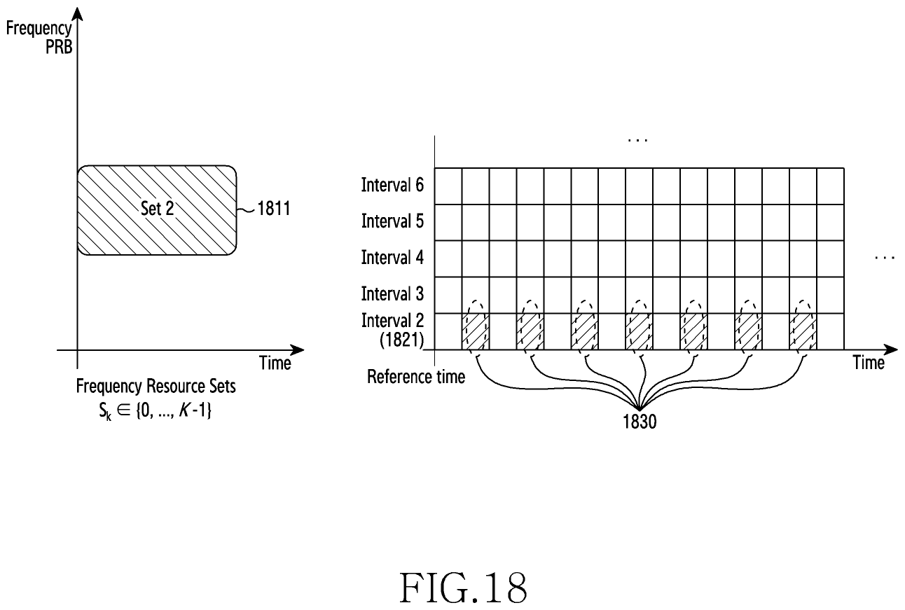

FIG. 18 illustrates another example in which a collision occurs in a sidelink of a wireless communication system according to an embodiment of the disclosure. In particular, FIG. 18 illustrates an example in which UEs use the same frequency resource and the same time resource according to an embodiment.

In the wireless communication system, when a plurality of UEs transmits signals using the same frequency resource and the same time resource, a collision may occur.

Referring to FIG. 18, when a second UE 1022 and a third UE 1023 transmit signals, based on the same frequency resource set 1811 and the same time interval 1821, collision instances 1830 may occur in each time slot.

In this case, a first UE 1021 according to an embodiment may transmit a third signal 1003 including a fourth value (e.g., 11) for requesting each UE (e.g., the second UE 1022 and the third terminal 1032) to reconfigure a resource and retransmit a signal as status information. A UE (e.g., the second UE 1022 and the third UE 1023) receiving the third signal 1003 having the fourth value as status information may reconfigure a resource and then retransmit a signal.

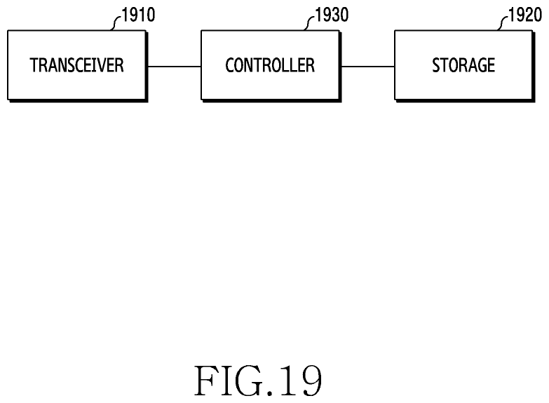

FIG. 19 illustrates a structure of a UE (e.g., the first UE 1021, second UE 1022, or third UE 1023) according to an embodiment of the disclosure.

Referring to FIG. 19, the UE of the disclosure may include a transceiver 1910, a storage 1920, and a controller (or processor) 1930. The controller 1930, the transceiver 1910, and the storage 1920 of the UE may be operated according to the above-described communication methods of the UE. Components of the UE are not limited to the above-described example. For example, the UE may include a larger or smaller number of components than the above-described components. Furthermore, the controller 1930, the transceiver 1910, and the storage 1920 may be implemented as single hardware (e.g., in the form of a chip).

The transceiver 1910 refers to a UE receiver and a UE transmitter as a whole, and may transmit/receive signals with other UEs, base stations, or network entities. The signals transmitted/received with other UEs or base stations may include control information and data. To this end, the transceiver 1910 may include a radio frequency (RF) transmitter configured to up-convert and amplify the frequency of transmitted signals, an RF receiver configured to low-noise-amplify received signals and down-convert the frequency thereof, and the like. However, this is only an embodiment of the transceiver 1910, and the components of the transceiver 1910 are not limited to the RF transmitter and the RF receiver.

Also, the transceiver 1910 may include wired/wireless transceivers, and may include various components for transmitting/receiving signals. In addition, the transceiver 1910 may receive signals through a radio channel, output the same to the controller 1930, and transmit signals output from the controller 1930 through the radio channel. Furthermore, the transceiver 1910 may receive communication signals, output same to a controller 1930, and transmit signals output from the controller 1930 to other UEs or base stations through a wired/wireless network.

The storage 1920 may store programs and data necessary for operations of the UE. In addition, the storage 1920 may store control information or data included in signals acquired by the UE. The storage 1920 may include storage media such as read only memory (ROM), random access memory (RAM), a hard disk, a compact disc-ROM (CD-ROM), flash memory, a solid state drive (SSD), and a digital versatile disc (DVD), or a combination of storage media.

The controller 1930 may control a series of processes such that the UE can operate according to the above-described embodiments of the disclosure. The controller 1930 may include one or more processors. For example, the controller 1930 may include a communication processor (CP) configured to perform control for communication, and an application processor (AP) configured to control upper layers such as application programs.

A first UE in a wireless communication system according to an embodiment may include a transceiver, memory storing one or more instructions, and at least one processor operatively connected to the transceiver. The one or more instructions may, when executed by the at least one processor, cause the first UE to receive at least one of a first signal broadcast from a second UE or a second signal broadcast from a third UE. The one or more instructions may, when executed by the at least one processor, cause the first UE to determine whether retransmission is needed or whether a collision occurs, based on at least one of the first signal or the second signal. The one or more instructions may, when executed by the at least one processor, cause the first UE to broadcast a third signal including frequency resource information, time resource information, and status information determined based on whether the determined retransmission is needed or whether the collision occurs.

In an embodiment, the status information may include any one of a first value indicating a state in which the first UE broadcasts data, based on whether the determined retransmission is needed or whether the collision occurs, a second value indicating a state in which power ramping is required, a third value indicating a state in which a UE other than a designated UE is required to perform signal transmission based on a different frequency resource or a different time resource, or a fourth value indicating a state in which reconfiguration is required.

In an embodiment, the one or more instructions may, when executed by the at least one processor, cause the first UE to broadcast the third signal including the status information corresponding to the second value when at least one of the second UE or the third UE is identified based on at least one or the first signal or the second signal and decoding of at least one of the first signal or the second signal fails.

In an embodiment, the one or more instructions may, when executed by the at least one processor, cause the first UE to decode the first signal and the second signal. The one or more instructions may, when executed by the at least one processor, cause the first UE to broadcast the third signal including the status information corresponding to the third value or the fourth value when determining that there is a collision between signal transmission of the second UE and signal transmission of the third UE, based on the first signal and the second signal.

In an embodiment, the one or more instructions may, when executed by the at least one processor, cause the first UE to determine first time resource information about the second UE, first frequency resource information about the second UE, second time resource information about the third UE, and second frequency resource information about the third UE, based on the first signal and the second signal. The one or more instructions may, when executed by the at least one processor, cause the first UE to determine whether a collision occurs, based on the first time resource information, the first frequency resource information, the second time resource information, and the second frequency resource information.

In an embodiment, the one or more instructions may, when executed by the at least one processor, cause the first UE to broadcast the third signal including the status information corresponding to the third value when the first time resource information and the second time resource information do not match. The one or more instructions may, when executed by the at least one processor, cause the first UE to broadcast the third signal including the status information corresponding to the fourth value when the first time resource information and the second time resource information match.

In an embodiment, the one or more instructions may, when executed by the at least one processor, cause the first UE to broadcast the third signal including the frequency resource information and the time resource information corresponding to a UE to be designated among the second UE or the third UE when the third signal including the status information corresponding to the third value is broadcast.

A second UE in a wireless communication system according to an embodiment may include a transceiver, memory storing one or more instructions, and at least one processor operatively connected to the transceiver. The one or more instructions may, when executed by the at least one processor, cause the second UE to broadcast a first signal. The one or more instructions may, when executed by the at least one processor, cause the second UE to receive a third signal broadcast from a first UE receiving at least one of the first signal or a second signal broadcast from a third UE. The one or more instructions may, when executed by the at least one processor, cause the second UE to obtain frequency resource information, time resource information, and status information from the third signal. The one or more instructions may, when executed by the at least one processor, cause the second UE to perform communication with the first UE, based on at least one of the frequency resource information, the time resource information, or the status information.

In an embodiment, the one or more instructions may, when executed by the at least one processor, cause the second UE to broadcast a fourth signal, based on increased power, based on the status information including a value indicating a state in which power ramping is required.

In an embodiment, the one or more instructions may, when executed by the at least one processor, cause the second UE to compare the frequency resource information and the time resource information with a frequency resource set and a time interval set used to transmit the first signal, based on the status information including a value indicating that a collision occurs. The one or more instructions may, when executed by the at least one processor, cause the second UE to determine whether to change a frequency resource and a time interval for broadcasting, based on a comparison result.

An operating method of a first UE according to an embodiment may include receiving at least one of a first signal broadcast from a second terminal or a second signal broadcast from a third UE. The operating method of the first UE may include determining whether retransmission is needed or whether a collision occurs, based on at least one of the first signal or the second signal. The operating method of the first UE may include broadcasting a third signal including frequency resource information, time resource information, and status information determined based on whether the determined retransmission is needed or whether the collision occurs.

In an embodiment, the status information may include any one of a first value indicating a state in which the first UE performs broadcasting, based on whether the determined retransmission is needed or whether the collision occurs, a second value indicating a state in which power ramping is required, a third value indicating a state in which a UE other than a designated UE is required to perform signal transmission based on a different frequency resource or a different time resource, or a fourth value indicating a state in which reconfiguration is required.

In an embodiment, the broadcasting of the third signal may include identifying at least one of the second UE or the third UE, based on at least one of the first signal or the second signal and. The broadcasting of the third signal may include broadcasting the third signal including the status information corresponding to the second value when decoding of at least one of the first signal or the second signal fails.

In an embodiment, the broadcasting of the third signal may include decoding the first signal and the second signal. The broadcasting of the third signal may include determining whether there is a collision between signal transmission of the second UE and signal transmission of the third UE, based on the first signal and the second signal. The broadcasting of the third signal may include broadcasting the third signal including the status information corresponding to the third value or the fourth value when determining that there is the collision between the signal transmission of the second UE and the signal transmission of the third UE, based on the first signal and the second signal.

In an embodiment, the determining whether there is the collision between the signal transmission of the second UE and the signal transmission of the third UE may include determining a first transmission time interval for the second UE, first frequency resource information about the second UE, a second transmission time interval for the third UE, and second frequency resource information about the third UE, based on the first signal and the second signal. The determining whether there is the collision between the signal transmission of the second UE and the signal transmission of the third UE may include determining whether the collision occurs, based on the first transmission time interval, the first frequency resource information, the second transmission time interval, and the second frequency resource information

In an embodiment, the broadcasting of the third signal to include the status information corresponding to the third value or the fourth value may include broadcasting the third signal including the status information corresponding to the third value when the first transmission time interval and the second transmission time interval do not match and broadcasting the third signal including the status information corresponding to the fourth value when the first transmission time interval and the second transmission time interval match.

In an embodiment, the broadcasting of the third signal may include broadcasting the third signal including the frequency resource information and the time resource information corresponding to a UE to be designated among the second UE or the third UE when the third signal including the status information corresponding to the third value is broadcast.

An operating method of a second UE according to an embodiment may include broadcasting a first signal. The operating method of the second UE may include receiving a third signal broadcast from a first UE receiving at least one of the first signal or a second signal broadcast from a third UE. The operating method of the second UE may include obtaining frequency resource information, time resource information, and status information from the third signal. The operating method of the second UE may include performing communication with the first UE, based on at least one of the frequency resource information, the time resource information, or the status information.

In an embodiment, the performing of the communication with the first UE may include broadcasting a fourth signal, based on increased power, based on the status information including a value indicating a state in which power ramping is required.

In an embodiment, the performing of the communication with the first UE may include comparing the frequency resource information and the time resource information with a frequency resource set and a time interval set used to transmit the first signal, based on the status information including a value indicating that a collision occurs. The performing of the communication with the first UE may include determining whether to change a frequency resource and a time interval for broadcasting, based on a comparison result.

In an embodiment, a non-transitory computer-readable recording medium may record a computer program to perform any one of the foregoing methods.

According to various embodiments of the disclosure, there may be provided an electronic device and an operating method thereof that enable reliable communication in an out-of-coverage (OOC) scenario.

According to various embodiments of the disclosure, there may be provided an electronic device and an operating method thereof for improving reliability of communication while reducing an increase in overhead even by using a communication mode of broadcasting a signal.

According to various embodiments of the disclosure, there may be provided an electronic device and an operating method thereof capable of requesting retransmission and reducing the probability of a collision when a collision occurs between UEs broadcasting signals.

Advantageous effects obtainable from the disclosure may not be limited to the above-mentioned effects, and other effects which are not mentioned herein may be clearly understood from the following description by those skilled in the art to which the disclosure pertains.

In the disclosure, functions or operations performed by an electronic device may be performed by one or more processors executing one or more instructions stored in memory. The functions or operations of the electronic device mentioned in the disclosure may be performed by one processor executing the one or more instructions, or may be performed by a combination of a plurality of processors executing the one or more instructions. The processors mentioned in the disclosure may be understood to include a circuit for performing a calculation or controlling other components of the electronic device. For example, the one or more processors may include a central processing unit (CPU), a microprocessor unit (MPU), an application processor (AP), a communication processor (CP), a neural processing unit (NPU), a system-on-chip (SoC), or an integrated circuit (IC) configured to execute the one or more instructions. The one or more processors may be configured to perform the operations of the electronic device described above.

As used herein, programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. The memory may include a single storage medium or a combination of multiple storage media. The above one or more instructions may be stored in a single storage medium or distributedly stored in multiple storage media.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the disclosure, the term “unit” or “module” may refer to a hardware component such as a processor or circuit, and/or a software component executed by a hardware component such as a processor.

The “unit” or “module” may be stored in an addressable storage medium and may be implemented by a program executable by a processor. For example, the “unit” or “module” may be implemented by elements such as software elements, object-oriented software elements, class elements, and task elements, processes, functions, attributes, procedures, sub-routines, segments of program codes, drivers, firmware, micro-codes, circuits, data, databases, data structures, tables, arrays, and parameters.

Particular implementations described herein are merely an embodiment, and do not limit the scope of the disclosure in any way. For the brevity and conciseness of the specification, a description of conventional electronic components, control systems, software, and other functional aspects of these systems may be omitted.

Also, as used herein, the expression “including at least one of a, b, or c” may mean “including only a”, “including only b”, “including only c”, “including a and b”, “including b and c”, “including a and c”, or “including a, b, and c all”.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A first terminal in a wireless communication system, the first terminal comprising:
a transceiver;
memory, comprising one or more storage media, storing instructions; and
one or more processors communicatively coupled to the transceiver and the memory,
wherein the instructions, when executed by the one or more processors individually or collectively, cause the first terminal to:
receive at least one of a first signal broadcast from a second terminal or a second signal broadcast from a third terminal,
determine whether retransmission is needed or whether a collision occurs, based on at least one of the first signal or the second signal, and
broadcast a third signal comprising frequency resource information, time resource information, and status information determined based on whether the retransmission is needed or whether the collision occurs.

2. The first terminal of claim 1, wherein the status information comprises, based on whether the retransmission is needed or whether the collision occurs, one of:
a first value indicating a state in which the first terminal broadcasts data;
a second value indicating a state in which a power increase is required;
a third value indicating a state in which a terminal other than a designated terminal is required to perform signal transmission based on a different frequency resource or a different time resource; or
a fourth value indicating a state in which reconfiguration is required.

3. The first terminal of claim 2, wherein the instructions, when executed by the one or more processors individually or collectively, further cause the first terminal to:
in case that at least one of the second terminal or the third terminal is identified based on at least one of the first signal or the second signal and decoding of at least one of the first signal or the second signal fails, broadcast the third signal comprising the status information corresponding to the second value.

4. The first terminal of claim 2, wherein the instructions, when executed by the one or more processors individually or collectively, further cause the first terminal to:
decode the first signal and the second signal; and
in case that it is determined that signal transmission of the second terminal collides with signal transmission of the third terminal, based on the first signal and the second signal, broadcast the third signal comprising the status information corresponding to the third value or the fourth value.

5. The first terminal of claim 4, wherein the instructions, when executed by the one or more processors individually or collectively, further cause the first terminal to:
determine first time resource information about the second terminal, first frequency resource information about the second terminal, second time resource information about the third terminal, and second frequency resource information about the third terminal, based on the first signal and the second signal; and
determine whether the collision occurs, based on the first time resource information, the first frequency resource information, the second time resource information, and the second frequency resource information.

6. The first terminal of claim 5, wherein the instructions, when executed by the one or more processors individually or collectively, further cause the first terminal to:
in case that the first time resource information and the second time resource information do not match, broadcast the third signal comprising the status information corresponding to the third value; and
in case that the first time resource information and the second time resource information match, broadcast the third signal comprising the status information corresponding to the fourth value.

7. The first terminal of claim 2, wherein the instructions, when executed by the one or more processors individually or collectively, further cause the first terminal to:
in case of broadcasting the third signal comprising the status information corresponding to the third value, broadcast the third signal comprising the frequency resource information and the time resource information corresponding to a terminal to be designated among the second terminal or the third terminal.

8. A second terminal in a wireless communication system, the second terminal comprising:
a transceiver;
memory, comprising one or more storage media, storing instructions; and
one or more processors communicatively coupled to the transceiver and the memory,
wherein the instructions, when executed by the one or more processors individually or collectively, cause the second terminal to:
broadcast a first signal,
receive a third signal broadcast from a first terminal receiving at least one of the first signal or a second signal broadcast from a third terminal,
obtain frequency resource information, time resource information, and status information from the third signal, and
perform communication with the first terminal, based on at least one of the frequency resource information, the time resource information, or the status information.

9. The second terminal of claim 8, wherein the instructions, when executed by the one or more processors individually or collectively, further cause the second terminal to:
based on the status information comprising a value indicating a state in which a power increase is required, broadcast a fourth signal, based on increased power.

10. The second terminal of claim 8, wherein the instructions, when executed by the one or more processors individually or collectively, further cause the second terminal to:
based on the status information comprising a value indicating that a collision occurs, compare the frequency resource information and the time resource information with a frequency resource set and a time interval set used to transmit the first signal; and
determine whether to change a frequency resource and a time interval for broadcasting, based on a result of the comparing.

11. A method performed by a first terminal, the method comprising:
receiving, by the first terminal, at least one of a first signal broadcast from a second terminal or a second signal broadcast from a third terminal;
determining, by the first terminal, whether retransmission is needed or whether a collision occurs, based on at least one of the first signal or the second signal; and
broadcasting, by the first terminal, a third signal comprising frequency resource information, time resource information, and status information determined based on whether the retransmission is needed or whether the collision occurs.

12. The method of claim 11, wherein the status information comprises, based on whether the retransmission is needed or whether the collision occurs, one of:
a first value indicating a state in which the first terminal performs broadcasting;
a second value indicating a state in which a power increase is required;
a third value indicating a state in which a terminal other than a designated terminal is required to perform signal transmission based on a different frequency resource or a different time resource; or
a fourth value indicating a state in which reconfiguration is required.

13. The method of claim 12, wherein the broadcasting of the third signal comprises:
identifying, by the first terminal, at least one of the second terminal or the third terminal, based on at least one or the first signal or the second signal and; and
based on decoding of at least one of the first signal or the second signal failing, broadcasting, by the first terminal, the third signal comprising the status information corresponding to the second value.

14. The method of claim 12, wherein the broadcasting of the third signal comprises:
decoding, by the first terminal, the first signal and the second signal;
determining, by the first terminal, whether signal transmission of the second terminal collides with signal transmission of the third terminal, based on the first signal and the second signal; and
based on determining that the signal transmission of the second terminal collides with the signal transmission of the third terminal, based on the first signal and the second signal, broadcasting, by the first terminal, the third signal comprising the status information corresponding to the third value or the fourth value.

15. The method of claim 14, wherein the determining of whether signal transmission of the second terminal collides with signal transmission of the third terminal comprises:
determining, by the first terminal, a first transmission time interval for the second terminal, first frequency resource information for the second terminal, a second transmission time interval for the third terminal, and second frequency resource information for the third terminal based on the first signal and the second signal; and
determining, by the first terminal, whether collision occurs based on the first transmission time interval, the first frequency resource information, the second transmission time interval and the second frequency resource information.

16. The method of claim 15, wherein the broadcasting of the third signal comprising the status information corresponding to the third value or the fourth value comprises:
based on the first transmission time interval and the second transmission time interval not matching, broadcasting, by the first terminal, the third signal comprising the status information corresponding to the third value; and
based on the first transmission time interval and the second transmission time interval matching, broadcasting, by the first terminal, the third signal comprising the status information corresponding to the fourth value.

17. The method of claim 12, wherein the broadcasting of the third signal comprises:
based on broadcasting the third signal comprising the status information corresponding to the third value, broadcasting, by the first terminal, the third signal comprising the frequency resource information and the time resource information corresponding to a terminal to be designated among the second terminal or the third terminal.

18. A method performed by a second terminal, the method comprising:
broadcasting, by the second terminal, a first signal;
receiving, by the second terminal, a third signal broadcast from a first terminal receiving at least one of the first signal or a second signal broadcast from a third terminal;
obtaining, by the second terminal, frequency resource information, time resource information, and status information from the third signal; and
performing, by the second terminal, communication with the first terminal, based on at least one of the frequency resource information, the time resource information, or the status information.

19. The method of claim 18, wherein the performing of communication with the first terminal comprises:
based on the status information comprising a value indicating a state in which a power increase is required, broadcasting, by the second terminal, a fourth signal, based on increased power.

20. The method of claim 18, wherein the performing of communication with the first terminal comprises:
based on the status information comprising a value indicating that a collision occurs, comparing, by the second terminal, the frequency resource information and the time resource information with a frequency resource set and a time interval set used to transmit the first signal; and
determining, by the second terminal, whether to change a frequency resource and a time interval for broadcasting, based on a result of the comparing.

21. One or more non-transitory computer-readable storage media storing one or more computer programs including computer-executable instructions that, when executed by one or more processors of a first terminal individually or collectively, cause the first terminal to perform operations, the operations comprising:
receiving, by the first terminal, at least one of a first signal broadcast from a second terminal or a second signal broadcast from a third terminal;
determining, by the first terminal, whether retransmission is needed or whether a collision occurs, based on at least one of the first signal or the second signal; and
broadcasting, by the first terminal, a third signal including frequency resource information, time resource information, and status information determined based on whether the retransmission is needed or whether the collision occurs.

22. The one or more non-transitory computer-readable storage media of claim 21, wherein the status information comprises, based on whether the retransmission is needed or whether the collision occurs, one of:
a first value indicating a state in which the first terminal performs broadcasting;
a second value indicating a state in which a power increase is required;
a third value indicating a state in which a terminal other than a designated terminal is required to perform signal transmission based on a different frequency resource or a different time resource; or
a fourth value indicating a state in which reconfiguration is required.
